(19) United States
(12) Patent Application Publication
(10) Pub. No.: US 2017/0091186 A1
(43) Pub. Date: Mar. 30, 2017

(54) COMPUTER-READABLE RECORDING MEDIUM, EVENT FILTERING APPARATUS, AND EVENT FILTERING METHOD

(71) Applicant: FUJITSU LIMITED, Kawasaki-shi (JP)

(72) Inventor: Hiroshi Nakagawa, Kanazawa (JP)

(73) Assignee: FUJITSU LIMITED, Kawasaki-shi (JP)

(21) Appl. No.: 15/242,941

(22) Filed: Aug. 22, 2016

(30) Foreign Application Priority Data
Sep. 29, 2015 (JP) 2015-191961

(51) Int. Cl. G06F 17/30

(52) U.S. Cl. CPC G06F 17/3051; G06F 17/30548

(57) ABSTRACT

An event filtering apparatus estimates a value indicating a tendency of a feature amount related to a current event on the basis of a change in a tendency of a feature amount related to a past input event, calculates a value indicating a tendency of a feature amount related to a current event on the basis of an input current event, and sets filtering of an event to be a target event for event processing, on the basis of the estimated value and the calculated value.

### CROSS-REFERENCE TO RELATED APPLICATION(S)

This application is based upon and claims the benefit of priority of the prior Japanese Patent Application No. 2015-191961, filed on Sep. 29, 2015, the entire contents of which are incorporated herein by reference.

### FIELD

The embodiments discussed herein are related to a computer-readable recording medium having stored therein an event filtering program, and the like.

### BACKGROUND

In recent years, complex event processing (CEP) has been known as a technology for processing events that are collected every minute from various objects. In the complex event processing, a large amount of events are accepted, the events are filtered based on a filtering rule that is applied to execute the complex event processing, the filtered events are input to an CEP engine, and the input events are processed by the CEP engine (see, for example, Japanese Laid-open Patent Publication No. 2012-118928).

### SUMMARY

According to an aspect of an embodiment, a non-transitory computer-readable recording medium has a program stored therein. The program causes a computer to executes a process. The process includes estimating a value indicating a tendency of a feature amount related to a current event on the basis of a change in a tendency of a feature amount related to a past input event. The process includes calculating a value indicating a tendency of a feature amount related to a current event on the basis of an input current event. The process includes setting filtering of an event to be a target event for event processing, on the basis of the estimated value and the calculated value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an overall configuration of a CEP system including an event filtering apparatus according to a first embodiment;

FIG. 2 is a diagram illustrating an example of a data structure of a time-series data table;

FIG. 3 is a diagram illustrating an example of a data structure of an estimated data table;

FIG. 4 is a diagram illustrating an example of a data structure of a configuration file;

FIG. 5A is a first diagram illustrating an example of a specific process performed by the CEP system according to the first embodiment;

FIG. 5B is a second diagram illustrating an example of the specific process performed by the CEP system according to the first embodiment;

FIG. 6 is a flowchart illustrating an estimated data generation process according to the first embodiment;

FIG. 7 is a flowchart illustrating an event filtering process according to the first embodiment;

FIG. 8 is a diagram illustrating an overall configuration of a CEP system including an event filtering apparatus according to a second embodiment;

FIG. 9A is a first diagram illustrating an example of a specific process performed by the CEP system according to the second embodiment;

FIG. 9B is a second diagram illustrating an example of the specific process performed by the CEP system according to the second embodiment;

FIG. 10 is a flowchart illustrating an estimated data generation process according to the second embodiment;

FIG. 11 is a flowchart illustrating an event filtering process according to the second embodiment;

FIG. 12 is a diagram illustrating an overall configuration of a CEP system including an event filtering apparatus according to a third embodiment;

FIG. 13 is a diagram illustrating an example of a specific process performed by the CEP system according to the third embodiment;

FIG. 14 is a flowchart illustrating an event filtering process according to the third embodiment;

FIG. 15A is a first diagram illustrating an example of a specific process performed by the CEP system according to a fourth embodiment;

FIG. 15B is a second diagram illustrating an example of the specific process performed by the CEP system according to the fourth embodiment; and

FIG. 16 is a diagram illustrating an example of a computer that executes an event filtering program.

### DESCRIPTION OF EMBODIMENT(S)

In the conventional technology, it is difficult to appropriately filter events in the complex event processing.

For example, in the complex event processing, events are filtered based on a filtering rule, but the amount and contents of events input to an CEP engine are changed depending on the filtering rule to be used. Incidentally, in the complex event processing, events processed by the CEP engine have regularities and trends, but it is difficult to set a filtering rule in which the regularities and trends of the events are reflected. Therefore, the amount and contents of events input to the CEP engine are not always appropriate.

Preferred embodiments of the present invention will be explained with reference to accompanying drawings. In the following, a case will be described in which the event filtering apparatus of the disclosed technology is applied to a CEP system. Furthermore, a case will be described in which the CEP system is used to predict occurrence of congestion of cars. However, the event filtering apparatus of the disclosed technology is not limited to the embodiments below.

### [a] First Embodiment

### Configuration of a CEP System According to a First Embodiment

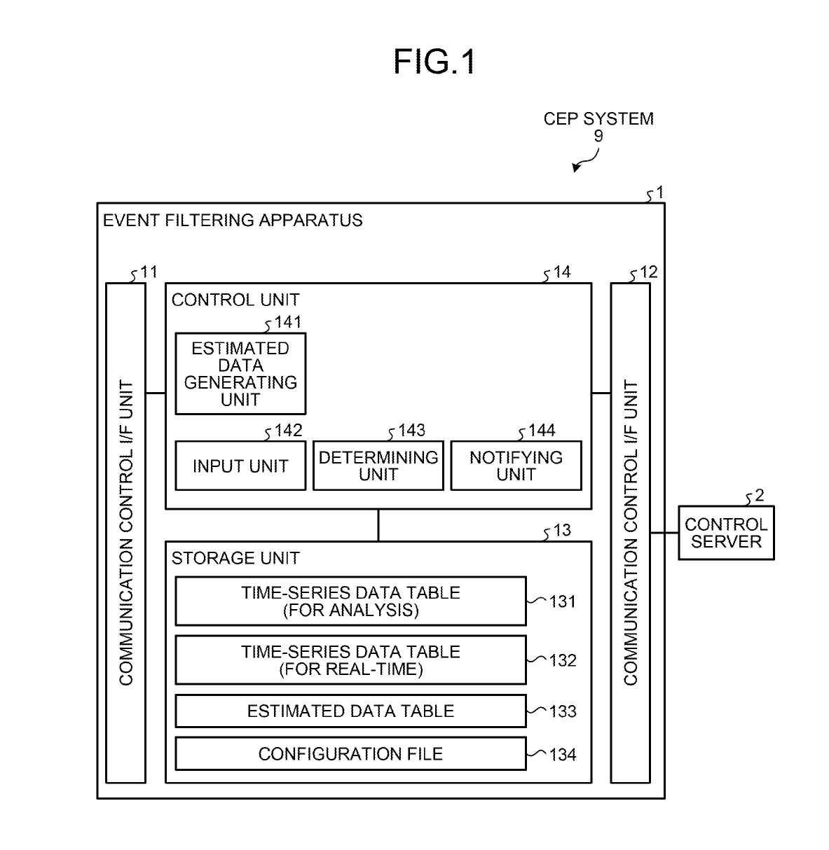

FIG. 1 is a diagram illustrating an overall configuration of a CEP system including an event filtering apparatus according to a first embodiment. As illustrated in FIG. 1, a CEP system 9 includes an event filtering apparatus 1 and a control server 2.

The event filtering apparatus 1 is a physical server that performs complex event processing, and is, for example, a server computer installed in a data center or each company. Multiple kinds of events are distributed (input) to the event filtering apparatus 1 from an event source that is an event input source. A plurality of event input sources are provided.

The control server 2 controls signals and speeds to avoid congestion.

In recent years, a large amount of events are input to the event filtering apparatus 1 from a plurality of input sources. Therefore, the event filtering apparatus 1 filters the events based on a filtering rule that is applied to perform complex event processing, and inputs the filtered events to a CEP engine. However, the optimality of the filtering rule changes depending on trends (tendencies) with respect to seasons or times. For example, in the tourist season, there is a tendency that a car event increases rapidly, and this tendency occurs routinely. Furthermore, in the middle of night, there is a tendency that a truck event increases, and this tendency occurs routinely. That is, the optimal filtering rule is different between a period in the tourist season and a period out of the tourist season. Furthermore, the optimal filtering rule is different for each of times.

Therefore, the event filtering apparatus 1 estimates a value (estimated value) indicating a tendency of a feature amount related to an input event that may be input in real time in the future, on the basis of a change in the tendency of the feature amount of an event (for example, a car event or a truck event) input in the past. The event filtering apparatus 1 calculates a value indicating the tendency of the feature amount of a current event on the basis of the current event that is actually input in real time. The event filtering apparatus 1 sets a filtering rule of an event to be sent to the CEP engine that performs event processing, on the basis of the estimated value and the calculated value.

The event filtering apparatus 1 includes communication control I/F units 11 and 12, a storage unit 13, and a control unit 14.

The communication control I/F units 11 and 12 are interfaces that control communication with a network. The communication control I/F unit 11 receives events distributed from various input sources. For example, the communication control I/F unit 11 receives a status, such as a location or a speed, of a running car, which is distributed from an input source in a predetermined area; receives a status, such as a location or a speed, of a running truck, which is distributed from a different input source in the same area; and receives information on weather, which is distributed from a different input source in the same area. The communication control I/F unit 12 notifies the control server 2 of information estimated from an event that is extracted in accordance with a filtering rule. Incidentally, in the following, for convenience of explanation, a car event, a truck event, and a weather forecast event received by the communication control I/F units 11 and 12 will be described as received events. However, the received events are not limited to the car event, the truck event, and the weather forecast event, but may be any event that is used to predict occurrence of congestion of cars.

The storage unit 13 is a storage device, such as a hard disk or an optical disk. The storage unit 13 may be a data-rewritable semiconductor memory, such as a random access memory (RAM), a read only memory (ROM), a flash memory, or a non volatile static random access memory (NVSRAM).

The storage unit 13 stores therein various kinds of information. For example, the storage unit 13 stores therein an operating system (OS) executed by the control unit 14 or a program for performing various processes, such as an estimated data generation process, an input process, a determination process, and a notification process, which will be described later. Furthermore, the storage unit 13 stores therein various kinds of data needed to execute the program executed by the control unit 14. For example, the storage unit 13 stores therein a time-series data table (for analysis) 131, a time-series data table (for real-time) 132, an estimated data table 133, and a configuration file 134.

The time-series data table (for analysis) 131 is a table for an analysis and is used to generate an estimated value. The time-series data table (for analysis) 131 is used at the time of an analysis before operation. The time-series data table (for analysis) 131 stores therein data corresponding to an event that is generated in each period by using a past log in which past input events are stored. The granularity for generating data is, for example, the unit of one minute, but may be the unit of one hour. Incidentally, a plurality of events are included in the same granularity even when the events are of the same type. Therefore, data corresponding to the same type of events in the same granularity is an averaged value. A data structure of the time-series data table (for analysis) 131 will be described later.

The time-series data table (for real-time) 132 is a table for real time, which is used when an event is input from an input source. The time-series data table (for real-time) 132 is used at the time of operation. The time-series data table (for real-time) 132 chronologically stores therein pieces of data corresponding to events input from input sources. The granularity for generating data is the same as the granularity used for the time-series data table (for analysis) 131. Incidentally, a plurality of events are included in the same granularity even when the events are of the same type. Therefore, data corresponding to events of the same type in the same granularity is an averaged value. A data structure of the time-series data table (for real-time) 132 will be described later.

The estimated data table 133 is a table for storing estimated data (estimated value). The estimated data table 133 chronologically stores therein pieces of estimated data (estimated values) corresponding to events. The granularity for generating data is the same as the granularity used for the time-series data table (for analysis) 131. A data structure of the estimated data table 133 will be described later.

The configuration file 134 stores therein a unit of generation indicating the granularity for generating data corresponding to an event, and a unit of analysis indicating a period used for an analysis. The configuration file 134 is set in advance before operation and analysis. A data structure of the configuration file 134 will be described later.

The control unit 14 includes a built-in memory for storing control data and a program in which various processing procedures are defined, and performs various processes by using the program and the control data. The control unit 14 corresponds to an electronic circuit of an integrated circuit, such as an application specific integrated circuit (ASIC) or a field programmable gate array (FPGA). Furthermore, the control unit 14 corresponds to an electronic circuit, such as a central processing unit (CPU) or a micro processing unit (MPU). Moreover, the control unit 14 includes an estimated data generating unit 141, an input unit 142, a determining unit 143, and a notifying unit 144.

The estimated data generating unit 141 generates estimated data (estimated value). That is, the estimated data generating unit 141 generates the estimated data table 133 at the time of an analysis before operation. For example, the estimated data generating unit 141 calculates an estimated value indicating a tendency of a feature amount related to a car event, a truck event, and a weather forecast event input in real time, on the basis of a change in the tendency of the feature amount related to a car event, a truck event, and a weather forecast event input in the past.

As one example, the estimated data generating unit 141 reads the unit of generation and the unit of analysis from the configuration file 134. The estimated data generating unit 141 extracts events in a state at a stationary time (stationary state) among past input events from a past log corresponding to a learning period, and calculates time-series values of the respective events in the unit of generation. The estimated data generating unit 141 performs this calculation by using, for example, a statistical analysis tool. Examples of the statistical analysis tool include “R”. Furthermore, the estimated data generating unit 141 stores the calculated time-series values of the respective events in the time-series data table (for analysis) 131. The learning period described herein is, for example, two weeks when the unit of analysis is set to, for example, one day; however, it is not limited thereto. Moreover, the stationary state described herein is a state in which an abnormality, such as an accident, has not occurred, and indicates a state in which a speed is lower than a predetermined speed when the events are car events, for example. Then, the estimated data generating unit 141 performs autoregression analysis by using the time-series values of the respective events stored in the time-series data table (for analysis) 131, and calculates time-series estimated values of the respective read events corresponding to the unit of analysis. The estimated data generating unit 141 stores the calculated time-series estimated values of the respective events in the estimated data table 133. The estimated value is an average value of an upper limit and a lower limit of a confidence interval when the confidence interval is set to, for example, 95%; however, it may be possible to include values from the lower limit to the upper limit. Incidentally, as the autoregression analysis, for example, vector autoregression (VAR) may be used; however, it is not limited thereto, and any statistical analysis that estimates a future value from the time-series data is applicable.

The input unit 142 inputs an event from an input source of an event source. For example, the input unit 142 inputs a car event, a truck event, and a weather forecast event from respective input sources of event sources. As one example, the events input from the input sources are described using a data structure in an extensible markup language (XML) format.

The determining unit 143 calculates a value indicating a tendency of a feature amount related to a current event on the basis of the current event that is input in real time. For example, the determining unit 143 calculates a value indicating the tendencies of feature amounts related to a car event, a truck event, and a weather forecast event on the basis of the feature amount related to each of the car event, the truck event, and the weather forecast event input from input sources in each period. As one example, the determining unit 143 reads the unit of generation and the unit of analysis from the configuration file 134. The determining unit 143 calculates values indicating tendencies of feature amounts related to various events in the read unit of generation, with respect to the various input current events. The determining unit 143 stores the calculated values of the various events in the time-series data table (for real-time) 132.

Furthermore, the determining unit 143 generates a filtering rule from the calculated value of a current event and the estimated value corresponding to a period in which the current event is input. The determining unit 143 determines a current event that is deviated from the estimated value on the basis of the generated filtering rule, and sends a determination result to the notifying unit 144. That is, the determining unit 143 performs filtering of an event to be sent to the CEP engine that performs event processing, on the basis of the calculated value and the estimated value of the event in each period. For example, the determining unit 143 reads, from the estimated data table 133, an estimated value corresponding to a period in which a current event is input. The determining unit 143 generates a filtering rule for comparing the calculated value of the current event and the read estimated value. If the calculated value matches the estimated value, the determining unit 143 sends the current event corresponding to the calculated value to the notifying unit 144. That is, the determining unit 143 sends, as an important event, an abnormal event deviated from the stationary state to the CEP engine. If the calculated value does not match the estimated value, the determining unit 143 performs filtering of the current event corresponding to the calculated value.

The notifying unit 144 notifies the control server 2 of a notice, as an important notice, indicating that an abnormality has occurred with respect to the event sent from the determining unit 143. For example, examples of the notice indicating occurrence of an abnormality include “congestion may occur”.

Data Structure of the Time-Series Data Table

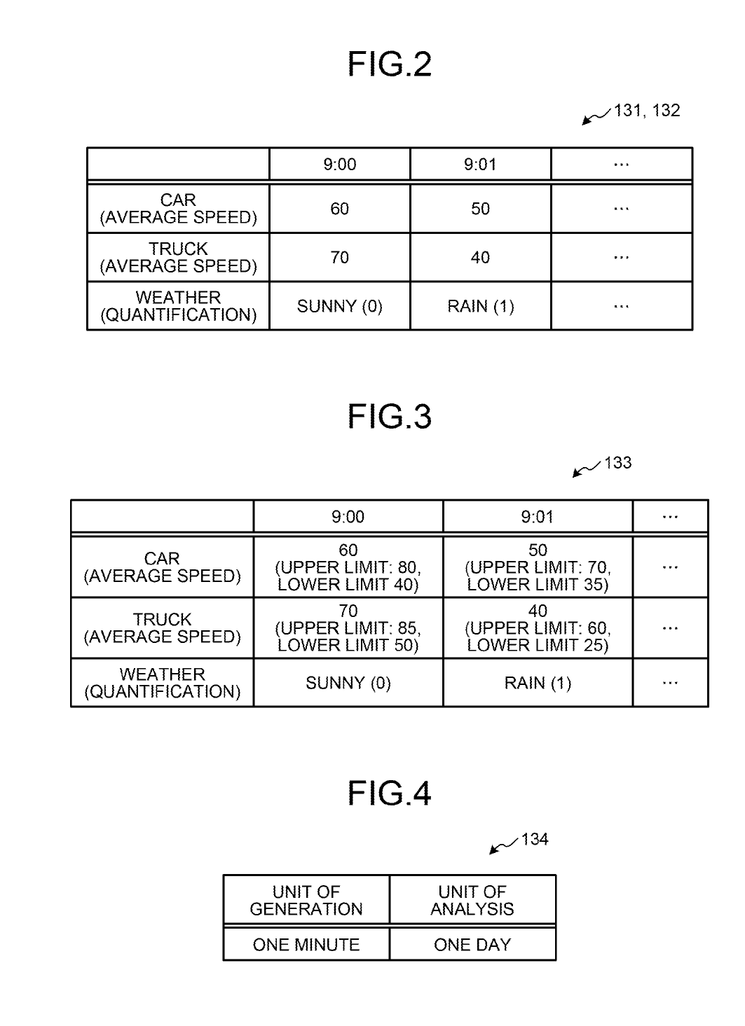

Next, data structures of the time-series data table (for analysis) 131 and the time-series data table (for real-time) 132 will be described with reference to FIG. 2. FIG. 2 is a diagram illustrating an example of the data structure of the time-series data table. As illustrated in FIG. 2, each of the time-series data tables 131 and 132 stores therein a value indicating a tendency of a feature amount related to an event for each period. Each period is indicated by the unit of generation. If the unit of generation is set to “one minute”, each period is one minute. If a plurality of the same type of events are input in a certain period, an average value of a plurality of values is stored as a value indicating a tendency of feature amounts related to the plurality of the same type of the events. As one example, if the unit of generation is set to “one minute”, “9:00”, “9:01”, . . . are stored as the periods. In the case of a period “9:00” indicating a period from “9:00” to before “9:01”, “60” is stored as a value indicating a tendency of cars (average speed). Furthermore, “70” is stored as a value indicating a tendency of trucks (average speed). Moreover, “sunny (0)” is stored as a value indicating a tendency of weather forecasts (quantification).

Data Structure of the Estimated Data Table

Next, a data structure of the estimated data table 133 will be described with reference to FIG. 3. FIG. 3 is a diagram illustrating an example of the data structure of the estimated data table. As illustrated in FIG. 3, the estimated data table 133 stores therein an estimated value indicating a tendency of a feature amount related to an event for each period. Each period is indicated by the unit of generation. If there are a plurality of events of the same type that are expected to be input in a certain period, an average value of a plurality of values is stored as a value indicating a tendency of a feature amount related to the plurality of the events of the same type. As one example, if the unit of generation is set to “one minute”, “9:00”, “9:01”, . . . are stored as the periods. In the case of the period “9:00” indicating the period from “9:00” to before “9:01”, “60 (upper limit is 80 and lower limit is 40)” is stored as an estimated value indicating a tendency of cars (average speed). Furthermore, “70” (upper limit is 85 and lower limit is 50) is stored as a value indicating a tendency of trucks (average speed). Moreover, “sunny (0)” is stored as a value indicating a tendency of weather forecasts (quantification).

Data Structure of the Configuration File

Next, a data structure of the configuration file 134 will be described with reference to FIG. 4. FIG. 4 is a diagram illustrating an example of a data structure of the configuration file. As illustrated in FIG. 4, the configuration file stores therein the unit of generation and the unit of analysis in an associated manner. The unit of generation indicates the granularity for generating data corresponding to an event. The unit of analysis indicates a period for an analysis. As one example, if the unit of generation is set to “one minute”, “one day” is stored as the unit of analysis.

Example of a Specific Process Performed by the CEP System

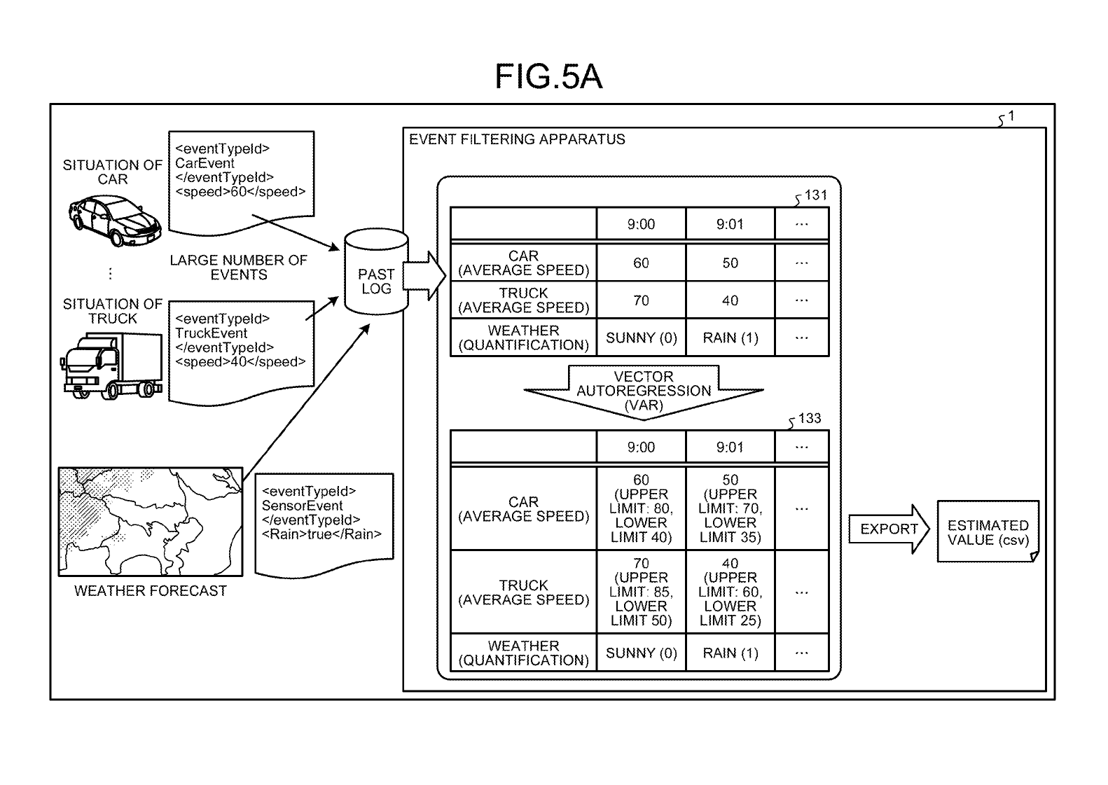

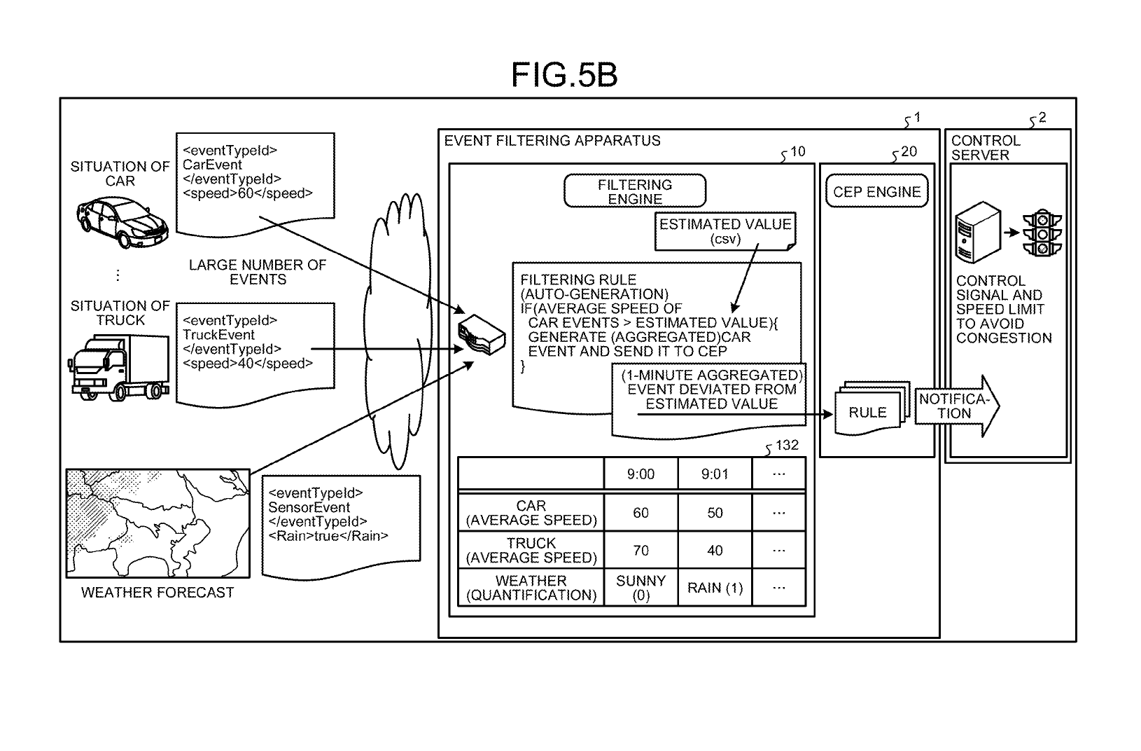

FIG. 5A and FIG. 5B are diagrams illustrating an example of a specific process performed by the CEP system according to the first embodiment. FIG. 5A illustrates a specific example of a process performed at the time of an analysis. FIG. 5B illustrates a specific example of real-time processing performed at the time of operation. Incidentally, it is assumed that “one minute” is stored as the unit of generation and “one day” is stored as the unit of analysis in the configuration file 134. Furthermore, the notifying unit 144 corresponds to, for example, a CEP engine 20. The input unit 142 and the determining unit 143 correspond to, for example, a filtering engine 10.

As illustrated in FIG. 5A, the event filtering apparatus 1 extracts car events, truck events, and weather forecast events in the stationary states from a past log in which past input events are stored, and stores the events in the time-series data table (for analysis) 131. In this example, the unit of generation in the configuration file 134 is set to “one minute”, and therefore, “9:00”, “9:01”, . . . are stored as the periods in the time-series data table (for analysis) 131. Furthermore, it is assumed that values for two weeks are stored. As one example, in the case of the period “9:00” indicating the period from “9:00” to before “9:01”, “60” is stored as a value indicating a tendency of cars (average speed), “70” is stored as a value indicating a tendency of trucks (average speed), and “sunny (0)” is stored as a value indicating a tendency of weather forecasts (quantification).

Then, the event filtering apparatus 1 performs autoregression analysis using VAR by using past records (time-series data) stored in the time-series data table (for analysis) 131, and calculates time-series estimated values of the respective events. Then, the event filtering apparatus 1 stores the calculated time-series estimated values of the respective events in the estimated data table 133. As one example, in the case of the period “9:00” indicating the period from “9:00” to before “9:01”, “60 (upper limit is 80 and lower limit is 40)” is stored as an estimated value indicating a tendency of cars (average speed). Furthermore, “70” (upper limit is 85 and lower limit is 50) is stored as a value indicating a tendency of trucks (average speed). Moreover, “sunny (0)” is stored as a value indicating a tendency of weather forecasts (quantification).

In the example in FIG. 5A, the event filtering apparatus 1 calculates an estimated value of each of the events for a next day from the pieces of the time-series data corresponding to the past two weeks. Then, the event filtering apparatus 1 outputs the estimated values stored in the estimated data table 133 in, for example, the csv format. The output estimated values are used in the real-time processing performed at the time of operation.

As illustrated in FIG. 5B, in the real-time processing at the time of operation, the event filtering apparatus 1 performs a process as described below. The filtering engine 10 of the event filtering apparatus 1 calculates an average speed indicating a tendency of a feature amount related to car events, from a plurality of the car events that are input from input sources during one minute. Similarly, the filtering engine 10 calculates an average speed indicating a tendency of a feature amount related to truck events, from a plurality of the truck events that are input from input sources during one minute. The filtering engine 10 calculates a value corresponding to an average weather indicating a tendency of a feature amount related to weather forecast events, from a plurality of the weather forecast events that are input from input sources during one minute. Then, the filtering engine 10 stores the calculated car events, truck events, and weather forecast events in the time-series data table (for real-time) 132. In this example, in the case of the period “9:00” indicating the period from “9:00” to before “9:01”, “60” is stored as a value indicating a tendency of cars (average speed), “70” is stored as a value indicating a tendency of trucks (average speed), and “sunny (0)” is stored as a value indicating a tendency of weather forecasts (quantification) in the time-series data table (for analysis) 131. Furthermore, in the case of a period “9:01” indicating a period from “9:01” to before “9:02”, “50” is stored as a value indicating a tendency of cars (average speed), “40” is stored as a value indicating a tendency of trucks (average speed), and “rain (1)” is stored as a value indicating a tendency of weather forecasts (quantification).

In parallel with the above process, the filtering engine 10 generates a filtering rule by using the estimated values output in the csv format. In this example, the filtering engine 10 generates a filtering rule for car events such that, for example, “if an average speed of car events exceeds an estimated value, an aggregated car event for one minute is generated and sent to the CEP engine 20”. As one example, in the case of the period “9:00” indicating the period from “9:00” to before “9:01”, the filtering engine 10 performs the following process. That is, the filtering engine 10 assigns “60”, which indicates cars (average speed) in this period, into a part corresponding to the average speed of car events in the filtering rule, and assigns the estimated value of cars (average speed) in a period corresponding to this period into a part corresponding to the estimated value. If the filtering rule is satisfied as a result of the assignment, the filtering engine 10 sends, to the CEP engine 20, an event in which the car events during this period are aggregated for one minute. That is, the filtering engine 10 sends an event that is deviated from the estimated value as an important event to the CEP engine 20. In other words, the filtering engine 10 sends an event that is deviated from the stationary state to the CEP engine 20. If the filtering rule is not satisfied as a result of the assignment, the filtering engine 10 does not send the car events of this period to the CEP engine 20. That is, the filtering engine 10 filters an event that is not deviated from the estimated value. Consequently, the event filtering apparatus 1 sends only an event that is deviated from the estimated value, so that it is possible to reduce load on the CEP engine 20.

The CEP engine 20 notifies the control server 2 that an abnormality has occurred with respect to the sent event. As one example, the CEP engine 20 notifies the control server 2 that “an abnormality has occurred with respect to cars during a time from 9:00 to 9:01”. Incidentally, a condition of the filtering rule is not limited to “a case in which an average speed of car events exceeds an estimated value”, but may be “an average speed of car events exceeds a lower limit of an estimated value”. The condition of the filtering rule depends on what state is indicated by the stationary state. In the above-described example, the stationary state indicates a low-speed state, and therefore, “a case in which an average speed of car events exceeds an estimated value” is applied. Consequently, the event filtering apparatus 1 can support control of the control server 2.

Flow of the Estimated Data Generation Process

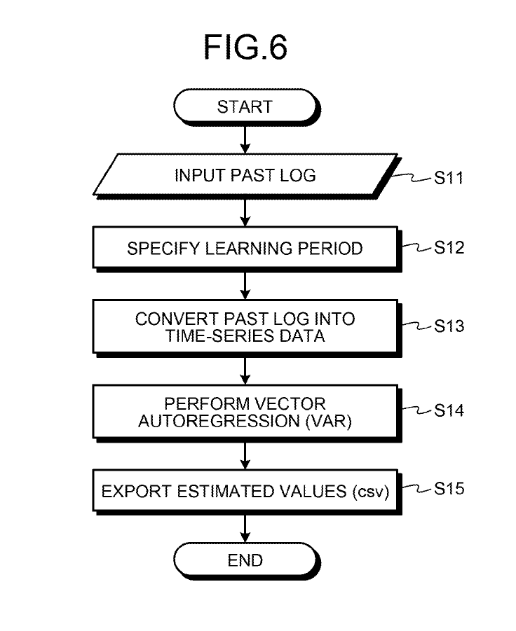

Next, the flow of the estimated data generation process will be described with reference to FIG. 6. FIG. 6 is a flowchart illustrating the estimated data generation process according to the first embodiment. Incidentally, in FIG. 6, a case will be described in which “R” is used as a statistical analysis tool. Furthermore, a case will be described in which a learning period is set to two weeks, the unit of generation is set to one minute, and the unit of analysis is set to one day.

First, the estimated data generating unit 141 inputs a past log, in which past input events are stored as supervised data (Step S11), and specifies a learning period (Step S12). Then, the estimated data generating unit 141 converts the past log corresponding to the learning period into time-series data (Step S13). As one example, the estimated data generating unit 141 extracts, from the past log, events for two weeks that are specified as the learning period, and converts the events into time-series values in the unit of generation (in the unit of 1 minute). Then, the estimated data generating unit 141 stores the converted time-series values of the respective events for the two weeks in the time-series data table (for analysis) 131.

Then, the estimated data generating unit 141 performs vector autoregression (VAR) and calculates estimated values corresponding to the unit of analysis (Step S14). As one example, the estimated data generating unit 141 performs autoregression analysis by using the time-series values of the respective events stored in the time-series data table (for analysis) 131, and calculates time-series estimated values of the respective events corresponding to the unit of analysis (one day). Then, the estimated data generating unit 141 stores the calculated time-series estimated values of the respective events corresponding to the unit of analysis (one day) in the estimated data table 133.

Then, the estimated data generating unit 141 exports the estimated values stored in the estimated data table 133 to the filtering engine 10 in the csv format (Step S15).

Flow of the Event Filtering Process

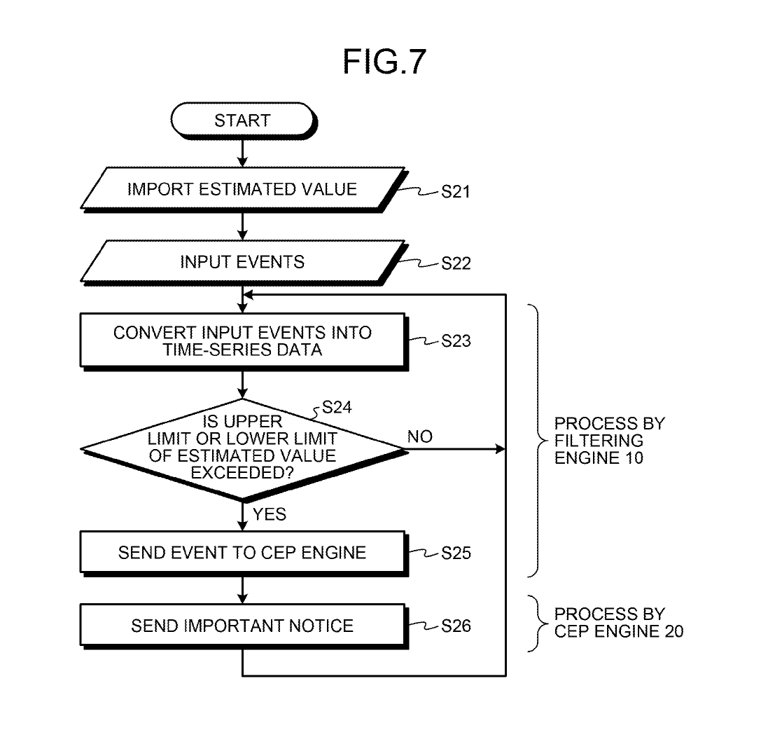

Next, the flow of the event filtering process will be described with reference to FIG. 7. FIG. 7 is a flowchart illustrating the event filtering process according to the first embodiment. Incidentally, a case will be described in which the unit of generation is set to one minute, and the unit of analysis is set to one day. Furthermore, in FIG. 7, it is assumed that the estimated data generating unit 141 exports the estimated value before operation starts.

In the event filtering process, the estimated value exported from the estimated data generating unit 141 is imported (Step S21).

When operation starts, the input unit 142 continuously inputs events from input sources (Step S22). Accordingly, the determining unit 143 converts the input events into pieces of time-series data (Step S23). As one example, the determining unit 143 converts the input events into time-series values in the unit of generation (unit of one minute). Then, the determining unit 143 stores the converted time-series values of the input events in the time-series data table (for real-time) 132.

Then, the determining unit 143 determines whether the value of the current input event exceeds the upper limit or the lower limit of the estimated value (Step S24). For example, the determining unit 143 generates a filtering rule by using the current estimated value corresponding to the unit of one minute, and determines whether the current input event matches the filtering rule. As one example, the determining unit 143 generates a filtering rule such that “if an average speed of car events exceeds an upper limit or a lower limit of an estimated value, an aggregated car event for one minute is generated and sent to the CEP engine 20”. Then, the determining unit 143 determines whether the value of the current input event matches the condition of the filtering rule.

When determining that the upper limit or the lower limit of the estimated value is exceeded (YES at Step S24), the determining unit 143 generates an aggregated event corresponding to one minute from the input events, and sends the generated event to the CEP engine 20 (Step S25). Then, the notifying unit 144 of the CEP engine 20 sends, as an important notice, a notice of occurrence of an abnormality with respect to the sent event to the control server 2 (Step S26). Then, the notifying unit 144 causes the process to proceed to Step S23 to cause the determining unit 143 to process a next input event.

In contrast, when determining that the upper limit and the lower limit of the estimated value are not exceeded (NO at Step S24), the determining unit 143 causes the process to proceed to Step S23 to process a next input event. Incidentally, if an interrupt indicating termination is received, the event filtering process is terminated.

Effects of the First Embodiment

According to the above-described first embodiment, the event filtering apparatus 1 estimates a value indicating a tendency of a feature amount related to a current event, on the basis of a change in a tendency of a feature amount related to a past input event. The event filtering apparatus 1 calculates a value indicating the tendency of the feature amount related to the current event, on the basis of the input current event. Then, the event filtering apparatus 1 sets filtering of an event to be sent to the CEP engine 20 that performs event processing, on the basis of the estimated value and the calculated value. With this configuration, the event filtering apparatus 1 sets filtering of an event based on the estimated value indicating the tendency of the feature amount related to the current event and based on a value indicating the tendency of the feature amount related to the input current event, so that it is possible to appropriately filter events. As a result, the event filtering apparatus 1 can reduce load on the event processing performed by the CEP engine 20.

Furthermore, according to the above-described first embodiment, the event filtering apparatus 1 estimates a value indicating the tendency of the feature amount related to the current event for each predetermined period, on the basis of a change in the tendency of feature amounts related to past input events. With this configuration, the event filtering apparatus 1 can estimate a value that changes depending on the tendency (trend), such as seasons or times, by estimating the estimated value indicating the tendency of the feature amount related to an event for each predetermined period. Consequently, the event filtering apparatus 1 can set appropriate filtering in accordance with the trend.

Moreover, according to the above-described first embodiment, the event filtering apparatus 1 sets a rule for filtering an event corresponding to the calculated value when the calculated value matches the estimated value. With this configuration, the event filtering apparatus 1 can filter an event corresponding to the calculated value that is not deviated from the estimated value, and can reduce load on the CEP engine 20.

### [b] Second Embodiment

In the first embodiment, the filtering engine 10 of the event filtering apparatus 1 sends an event deviated from the stationary state to the CEP engine 20, and the CEP engine 20 sends, as an important notice, a notice of occurrence of an abnormality with respect to the sent event to the control server 2. However, the present invention is not limited to this example, and the event filtering apparatus 1 specifies, at the time of an analysis before operation, an event that is deviated when an abnormality occurs, by using an event at the time of occurrence of a past abnormality as supervised data. Then, the event filtering apparatus 1 may set, at the time of operation, a second filtering rule for selecting a most important event by using the specified event that is deviated when an abnormality occurs, in addition to setting the filtering rule. Then, the event filtering apparatus 1 sends, as the most important notice to the control server 2, a notice of occurrence of an abnormality with respect to an event that matches the second filtering rule among events sent to the CEP engine 20.

Therefore, in a second embodiment, a case will be described in which the event filtering apparatus 1 sets, at the time of operation, the second filtering rule for selecting the most important event by using an event that is deviated when an abnormality occurs, in addition to setting the filtering rule.

Configuration of the CEP System According to the Second Embodiment

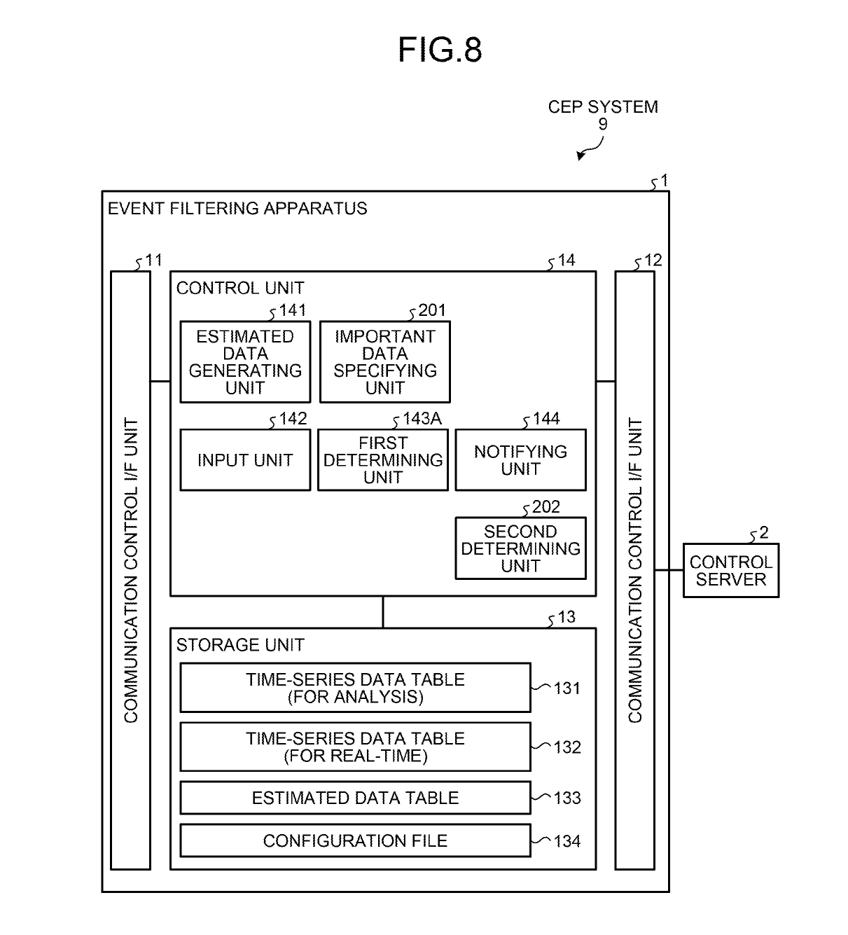

FIG. 8 is a diagram illustrating an overall configuration of a CEP system including an event filtering apparatus according to the second embodiment. The same components as those of the CEP system 9 illustrated in FIG. 1 are denoted by the same symbols, and explanation of the same configuration and operation will be omitted. The second embodiment is different from the first embodiment in that the control unit 14 further includes an important data specifying unit 201 and a second determining unit 202. Furthermore, the second embodiment is different from the first embodiment in that the determining unit 143 of the control unit 14 is renamed to a first determining unit 143A.

The important data specifying unit 201 specifies an event that is deviated when an abnormality occurs. For example, the important data specifying unit 201 reads the unit of generation from the configuration file 134. The important data specifying unit 201 extracts, from a past log, each input event at a date at which an accident or the like has occurred (an abnormality occurrence date) among past input events, and calculates time-series values of the respective events in the read unit of generation. The important data specifying unit 201 performs this calculation by using the same statistical analysis tool used by the estimated data generating unit 141. Then, the important data specifying unit 201 acquires a value of each of the events at an abnormality occurrence date and time (hours and minutes) among the calculated time-series values of the respective events. The important data specifying unit 201 compares the acquired values of the respective events and the estimated values of the respective events at the time corresponding to the abnormality occurrence date and time, and extracts events that are deviated from the estimated values. Incidentally, it is sufficient that the important data specifying unit 201 uses, as the estimated values of the respective events at the times, the estimated values that are generated by the first determining unit 143A and stored in the estimated data table 133. Then, the important data specifying unit 201 outputs the extracted events to the second determining unit 202. That is, the important data specifying unit 201 outputs the events that are deviated at the abnormality occurrence date and time to the second determining unit 202.

The first determining unit 143A performs the same operation as the determining unit 143 illustrated in FIG. 1, and therefore, explanation of the operation will be omitted.

The second determining unit 202 generates a filtering rule for comparing an event that is sent from the first determining unit 143A to the notifying unit 144 and an event that is output by the important data specifying unit 201 and that is deviated at the time of occurrence of an abnormality. That is, the second determining unit 202 uses the event, which is deviated at the time of occurrence of an abnormality, to select the most important event. Then, the second determining unit 202 sends, to the notifying unit 144, an event that matches the event that is deviated at the time of occurrence of an abnormality among the sent events, on the basis of the generated filtering rule. That is, when determining that the input event matches the event that is deviated at the time of occurrence of an abnormality, the second determining unit 202 sends the input event, as the most important event, to the notifying unit 144. Incidentally, determination on matching between the input event and the event that is deviated at the time of occurrence of an abnormality may be performed with respect to a type of the event, or may be performed with respect to a type of the event and a value of the event.

The notifying unit 144 notifies the control server 2 of a notice, as a most important notice, of occurrence of an abnormality with respect to the event sent from the second determining unit 202 among the events sent from the first determining unit 143A. The notifying unit 144 notifies the control server 2 of a notice, as an important notice, of occurrence of an abnormality with respect to the event that is not sent from the second determining unit 202 among the events sent from the first determining unit 143A. Incidentally, the important notice is a notice that is important among the notices of occurrence of abnormalities. Examples of the important notice include “congestion may occur”. The most important notice is a notice that is most important among the notices of occurrence of abnormalities. Examples of the most important notice include “a probability of occurrence of an accident is increased”.

Example of a Specific Process Performed by the CEP System

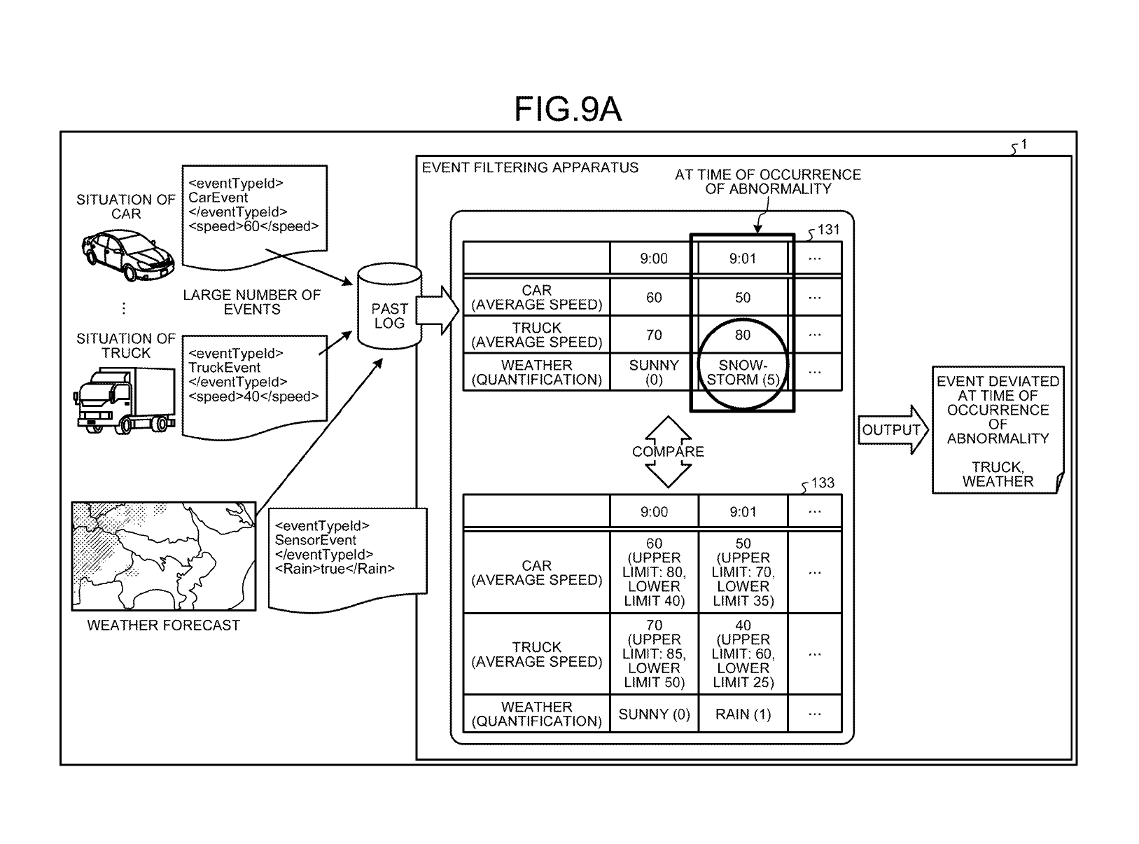

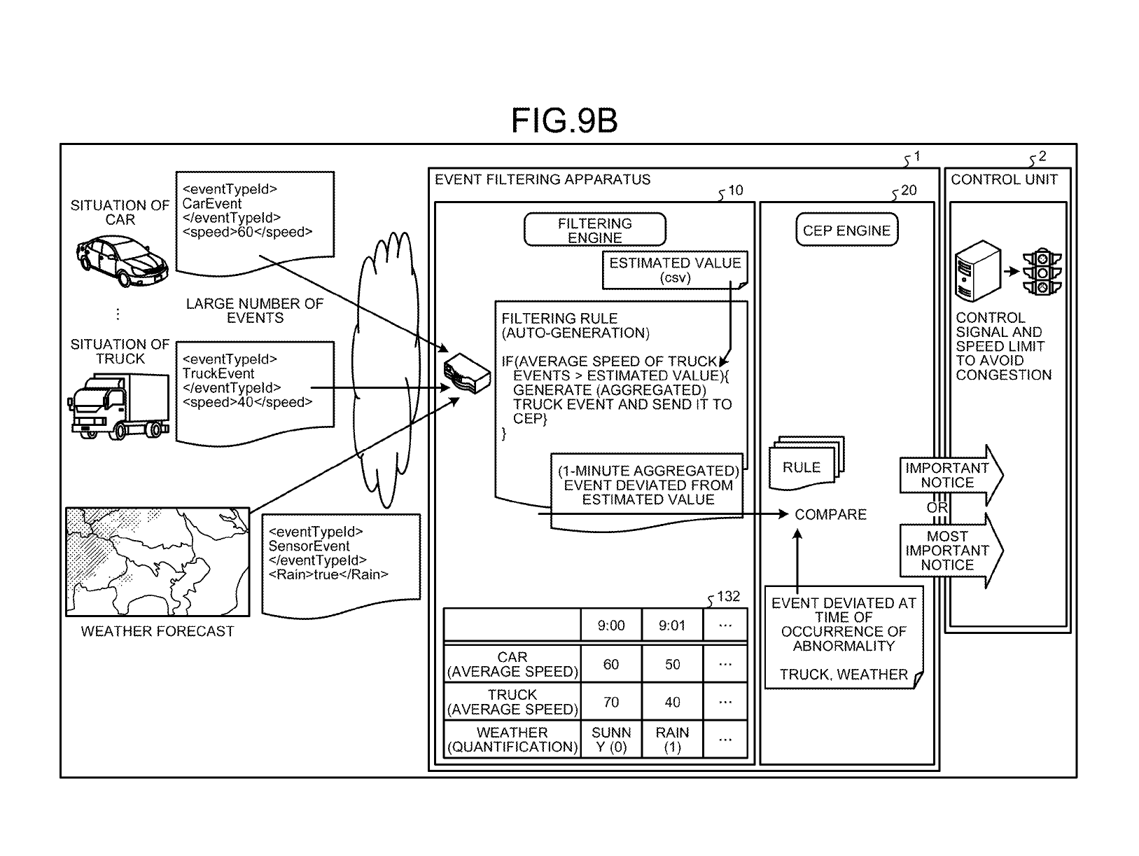

FIG. 9A and FIG. 9B are diagrams illustrating examples of a specific process performed by the CEP system according to the second embodiment. FIG. 9A illustrates a specific example of a process performed at the time of an analysis. FIG. 9B illustrates a specific example of real-time processing performed at the time of operation. Incidentally, it is assumed that “one minute” is stored as the unit of generation and “one day” is stored as the unit of analysis in the configuration file 134. Furthermore, it is assumed that the first determining unit 143A generates the estimated data table 133 corresponding to the unit of analysis of “one day”. Moreover, the notifying unit 144 and the second determining unit 202 correspond to, for example, the CEP engine 20. Furthermore, the input unit 142 and the first determining unit 143A correspond to, for example, the filtering engine 10.

As illustrated in FIG. 9A, the event filtering apparatus 1 extracts a car event, a truck event, and a weather forecast event at the abnormality occurrence date from a past log in which past input events are stored, and stores the events in the time-series data table (for analysis) 131. The event filtering apparatus 1 acquires values of the respective events corresponding to an abnormality occurrence date and time among the time-series values of the respective events. Here, for example, it is assumed that the abnormality occurrence date and time is “9:01”. Accordingly, “50” is acquired as a value indicating the tendency of cars (average speed) at the time of “9:01”, “80” is acquired as a value indicating the tendency of trucks (average speed), and “snowstorm (5)” is acquired as a value indicating the tendency of weather (quantification).

Then, the event filtering apparatus 1 compares the acquired values of the respective events and the estimated values of the respective events at the time corresponding to the abnormality occurrence date and time, and extracts events deviated from the estimated values. In this example, the estimated value indicating the tendency of cars (average speed) at the time corresponding to the abnormality occurrence date and time of “9:01” is “50”, the estimated value indicating the tendency of trucks (average speed) is “40”, and the estimated value indicating the tendency of weather (quantification) is “rain (1)”. In this case, the value of cars (average speed) at the abnormality occurrence date and time is the same as the estimated value of cars (average speed) at the corresponding time, and therefore is not deviated from the estimated value. In contrast, the value of trucks (average speed) at the abnormality occurrence date and time is greater than the estimated value of trucks (average speed) at the corresponding time, and therefore is deviated from the estimated value. Furthermore, the value of weather (quantification) at the abnormality occurrence date and time is greater than the estimated value, and therefore is deviated from the estimated value. Therefore, the event filtering apparatus 1 extracts the truck event and the weather event that are deviated from the estimated values with respect to the abnormality occurrence date and time of “9:01”.

Then, the event filtering apparatus 1 outputs the events that are deviated at the abnormality occurrence date and time to the CEP engine 20. In this example, the event filtering apparatus 1 outputs the truck event and the weather event at the abnormality occurrence date and time of “9:01” to the CEP engine 20. At this time, the event filtering apparatus 1 may output the events with the respective values. The output events are used in the real-time processing at the time of operation.

As illustrated in FIG. 9B, in the real-time processing at the time of operation, the event filtering apparatus 1 performs the following process. The filtering engine 10 of the event filtering apparatus 1 calculates an average speed indicating a tendency of a feature amount related to car events, from a plurality of the car events that are input from input sources during one minute. Similarly, the filtering engine 10 calculates an average speed indicating a tendency of a feature amount related to truck events, from a plurality of the truck events that are input from input sources during one minute. The filtering engine 10 calculates a value corresponding to an average weather indicating a tendency of a feature amount related to weather forecast events, from a plurality of the weather forecast events that are input from input sources during one minute. Then, the filtering engine 10 stores the calculated car events, truck events, and weather forecast events in the time-series data table (for real-time) 132.

In parallel with the above process, the filtering engine 10 generates a filtering rule by using the estimated values stored in the estimated data table 133. In this example, the filtering engine 10 generates a filtering rule for truck events such that, for example, “if an average speed of truck events exceeds an estimated value, an aggregated truck event for one minute is generated and sent to the CEP engine 20”. As one example, in the case of the period “9:00” indicating the period from “9:00” to before “9:01”, the filtering engine 10 performs the following process. That is, the filtering engine 10 assigns “70”, which indicates trucks (average speed) in this period, into a part corresponding to the average speed of truck events in the filtering rule, and assigns the estimated value of trucks (average speed) in this period into a part corresponding to the estimated value. If the filtering rule is satisfied as a result of the assignment, the filtering engine 10 sends, to the CEP engine 20, an event in which the truck events during this period are aggregated for one minute. That is, the filtering engine 10 sends an event that is deviated from the estimated value as an important event to the CEP engine 20. In other words, the filtering engine 10 sends an event that is deviated from the stationary state to the CEP engine 20. If the filtering rule is not satisfied as a result of the assignment, the filtering engine 10 does not send the truck events of this period to the CEP engine 20.

Then, the CEP engine 20 generates a filtering rule for comparing the output event and the sent event. In this example, the CEP engine 20 generates a filtering rule for, for example, determining whether the sent event matches the output truck event or the output weather event. Then, when determining that the sent event matches the output truck event or the output weather event, the CEP engine 20 sends, as the most important notice, a notice of occurrence of an abnormality to the control server 2. That is, when the sent event is the same as the event that is deviated at the time of occurrence of an abnormality, an abnormality is likely to occur; therefore the CEP engine 20 reports the event as a most important event. As one example, the CEP engine 20 sends a notice of “a probability of occurrence of an accident is increased” to the control server 2. When determining that the sent event does not match the output truck event and the output weather event, the CEP engine 20 sends a notice of occurrence of an abnormality as the important notice to the control server 2. As one example, the CEP engine 20 sends a notice of “congestion may occur” to the control server 2. Consequently, the event filtering apparatus 1 uses the event at the time of occurrence of an abnormality to determine notification, and therefore can transmit the most important notice to the control server 2 when the same event is input, and can support control of the control server 2.

Flow of the Estimated Data Generation Process

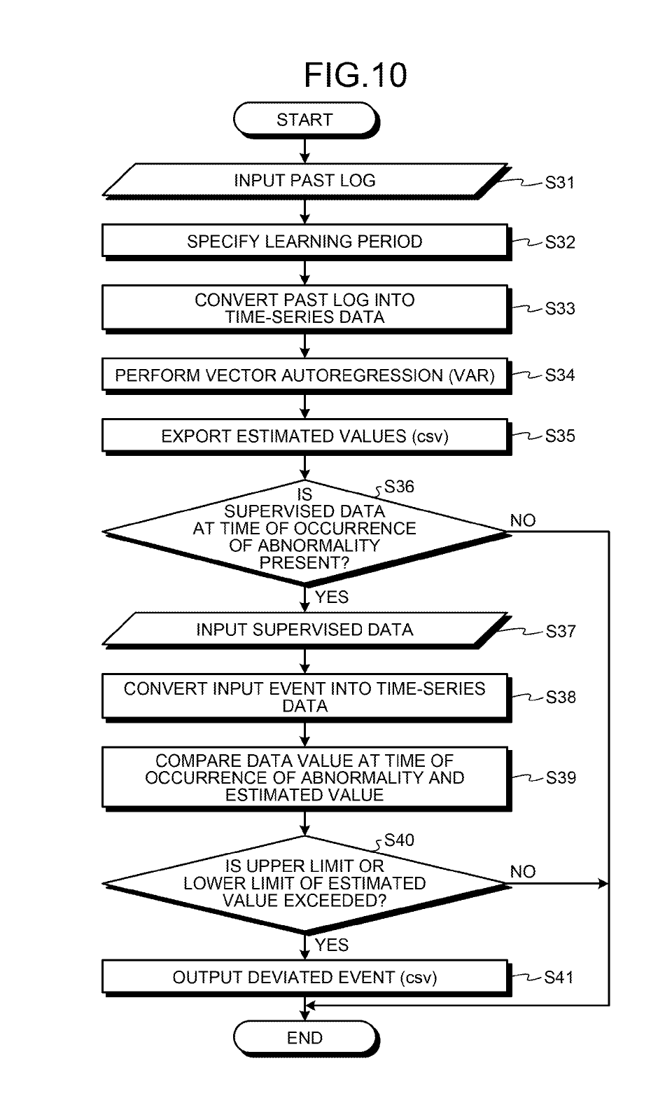

Next, the flow of the estimated data generation process will be described with reference to FIG. 10. FIG. 10 is a flowchart illustrating the estimated data generation process according to the second embodiment. In FIG. 10, a case will be described in which “R” is used as a statistical analysis tool. Furthermore, a case will be described in which a learning period is set to two weeks, the unit of generation is set to one minute, and the unit of analysis is set to one day.

First, the estimated data generating unit 141 inputs a past log, in which past input events are stored as supervised data (Step S31), and specifies a learning period (Step S32). Then, the estimated data generating unit 141 converts the past log corresponding to the learning period into time-series data (Step S33). As one example, the estimated data generating unit 141 extracts, from the past log, events for two weeks that are specified as the learning period, and converts the events into time-series values in the unit of generation (in the unit of 1 minute). Then, the estimated data generating unit 141 stores the converted time-series values of the respective events for the two weeks in the time-series data table (for analysis) 131.

Then, the estimated data generating unit 141 performs vector autoregression (VAR) and calculates estimated values corresponding to the unit of analysis (Step S34). As one example, the estimated data generating unit 141 performs autoregression analysis by using the time-series values of the respective events stored in the time-series data table (for analysis) 131, and calculates time-series estimated values of the respective events corresponding to the unit of analysis (one day). Then, the estimated data generating unit 141 stores the calculated time-series estimated values of the respective events corresponding to the unit of analysis (one day) in the estimated data table 133.

Then, the estimated data generating unit 141 exports the estimated values stored in the estimated data table 133 to the filtering engine 10 in the csv format (Step S35).

Subsequently, the important data specifying unit 201 determines whether supervised data at an abnormality occurrence date is present (Step S36). When determining that the supervised data at the abnormality occurrence date is not present (NO at Step S36), the important data specifying unit 201 ends the estimated data generation process without specifying important data.

In contrast, when determining that the supervised data at the abnormality occurrence date is present (YES at Step S36), the important data specifying unit 201 inputs the supervised data at the abnormality occurrence date (Step S37). The important data specifying unit 201 converts the input supervised data into the time-series data (Step S38). As one example, the important data specifying unit 201 extracts an event of the supervised data at the abnormality occurrence date from a past log, and converts the supervised data into a time-series data value in the unit of generation (in the unit of one minute).

Then, the important data specifying unit 201 compares the data value at the time of occurrence of an abnormality and the estimated value (Step S39). The important data specifying unit 201 determines whether the data value at the time of occurrence of an abnormality is deviated from an upper limit or a lower limit of the estimated value (Step S40). When determining that the data value at the time of occurrence of an abnormality is not deviated from the upper limit or the lower limit of the estimated value (NO at Step S40), the important data specifying unit 201 ends the estimated data generation process.

In contrast, when determining that the data value at the time of occurrence of an abnormality is deviated from the upper limit or the lower limit of the estimated value (YES at Step S40), the important data specifying unit 201 outputs an event of the deviated data value to the CEP engine 20 in the csv format (Step S41). Then, the important data specifying unit 201 ends the estimated data generation process.

Flow of the Event Filtering Process

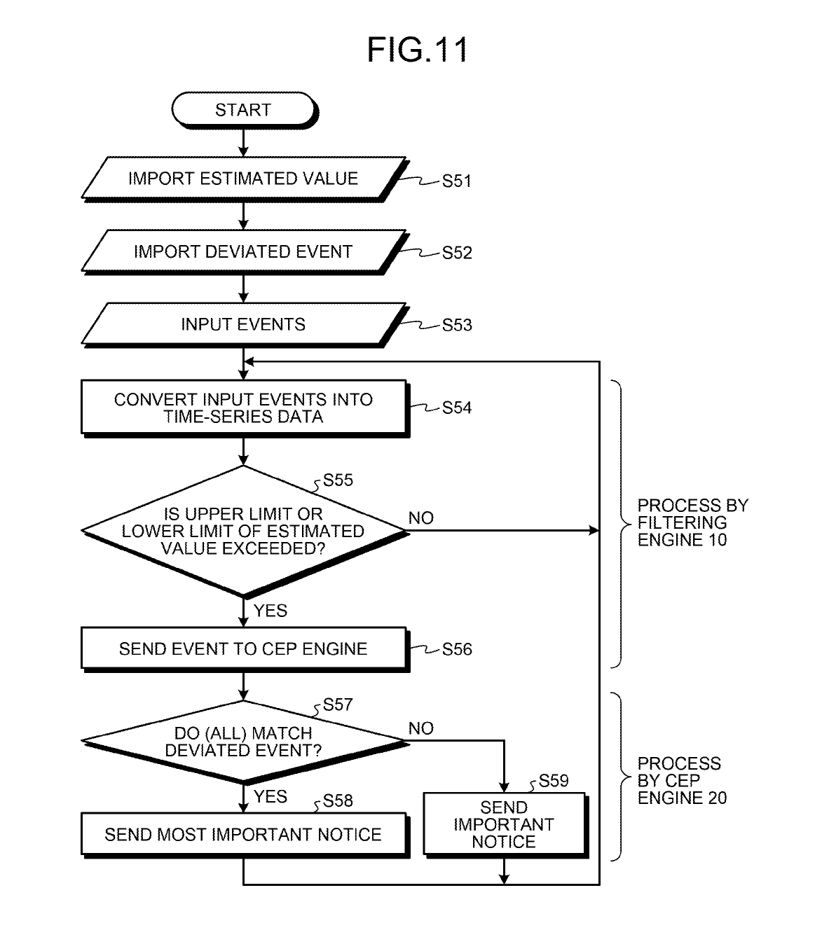

Next, the flow of the event filtering process will be described with reference to FIG. 11. FIG. 11 is a flowchart illustrating the event filtering process according to the second embodiment. Incidentally, a case will be described in which the unit of generation is set to one minute, and the unit of analysis is set to one day. Furthermore, in FIG. 11, it is assumed that the estimated data generating unit 141 exports the estimated value before operation starts. Moreover, it is assumed that the important data specifying unit 201 outputs an event that is deviated at the time of occurrence of an abnormality before operation starts.

In the event filtering process, the estimated value exported from the estimated data generating unit 141 is imported (Step S51). In the event filtering process, the deviated event output from the important data specifying unit 201 is imported (Step S52).

When operation starts, the input unit 142 continuously inputs events from input sources (Step S53). Accordingly, the first determining unit 143A converts the input events into time-series data (Step S54). As one example, the first determining unit 143A converts the input events into time-series values in the unit of generation (in the unit of one minute). Then, the determining unit 143 stores the converted time-series values of the input events in the time-series data table (for real-time) 132.

Then, the first determining unit 143A determines whether the value of the current input event exceeds the upper limit or the lower limit of the estimated value (Step S55). For example, the first determining unit 143A generates a filtering rule by using the current estimated value corresponding to the unit of one minute, and determines whether the current input event matches the filtering rule. As one example, the first determining unit 143A generates a filtering rule such that “if an average speed of truck events exceeds an upper limit or a lower limit of an estimated value, an aggregated truck event for one minute is generated and sent to the CEP engine 20”. Then, the first determining unit 143A determines whether the value of the current input event matches the condition of the filtering rule.

When determining that the upper limit or the lower limit of the estimated value is not exceeded (NO at Step S55), the first determining unit 143A causes the process to proceed to Step S54 to process a next input event.

In contrast, when determining that the upper limit or the lower limit of the estimated value is exceeded (YES at Step S55), the first determining unit 143A generates an aggregated event corresponding to one minute from the input events, and sends the generated event to the CEP engine 20 (Step S56). Then, the first determining unit 143A causes the process to proceed to Step S57.

At Step S57, the second determining unit 202 of the CEP engine 20 determines whether the sent event matches the imported event that is deviated at the time of occurrence of an abnormality (Step S57). Incidentally, determination on matching between the sent event and the deviated event may be performed with respect to a type of the event, or may be performed with respect to a type of the event and a value of the event.

If it is determined that the sent event matches the event that is deviated at the time of occurrence of an abnormality (YES at Step S57), the notifying unit 144 transmits, as the most important notice, a notice of occurrence of an abnormality with respect to the sent event to the control server 2 (Step S58). Then, the notifying unit 144 causes the process to proceed to Step S54 to cause the first determining unit 143A to process a next input event.

In contrast, if it is determined that the sent event does not match the event that is deviated at the time of occurrence of an abnormality (NO at Step S57), the notifying unit 144 transmits, as the important notice, a notice of occurrence of an abnormality with respect to the sent event to the control server 2 (Step S59). Then, the notifying unit 144 causes the process to proceed to Step S54 to cause the first determining unit 143A to process a next input event. Incidentally, if an interrupt indicating termination is received, the event filtering process is terminated.

Effects of the Second Embodiment

According to the above-described second embodiment, when determining that an event sent from the filtering engine 10 is abnormal based on a pre-stored event that is deviated at the time of occurrence of an abnormality, the event filtering apparatus 1 sends a determination result as the most important notice to the control server 2. With this configuration, the event filtering apparatus 1 can send the determination result as the most important notice to the control server 2 by using the event, which is deviated at the time of occurrence of an abnormality, to select the most important event. As a result, the event filtering apparatus 1 can support control of the control server 2.

### [c] Third Embodiment

In the first embodiment, the filtering engine 10 of the event filtering apparatus 1 sends an event deviated from the stationary state to the CEP engine 20, and the CEP engine 20 notifies the control server 2 of a notice, as the important notice, of occurrence of an abnormality with respect to the sent event. In the second embodiment, the event filtering apparatus 1 imports an event that is deviated at the time of occurrence of an abnormality to the CEP engine 20, and the CEP engine 20 uses the event, which is deviated at the time of occurrence of an abnormality, for determination to select the most important event and then notifies the control server 2 of a determination result as the most important notice. However, the event filtering apparatus 1 is not limited to this example. The CEP engine 20 may use the event, which is deviated at the time of occurrence of an abnormality, for determination to select the most important event and use a determination result for event processing.

Therefore, in a third embodiment, a case will be described in which the CEP engine 20 of the event filtering apparatus 1 uses the event, which is deviated at the time of occurrence of an abnormality, to select the most important event, and uses a determination result for event processing.

Configuration of the CEP System According to the Third Embodiment

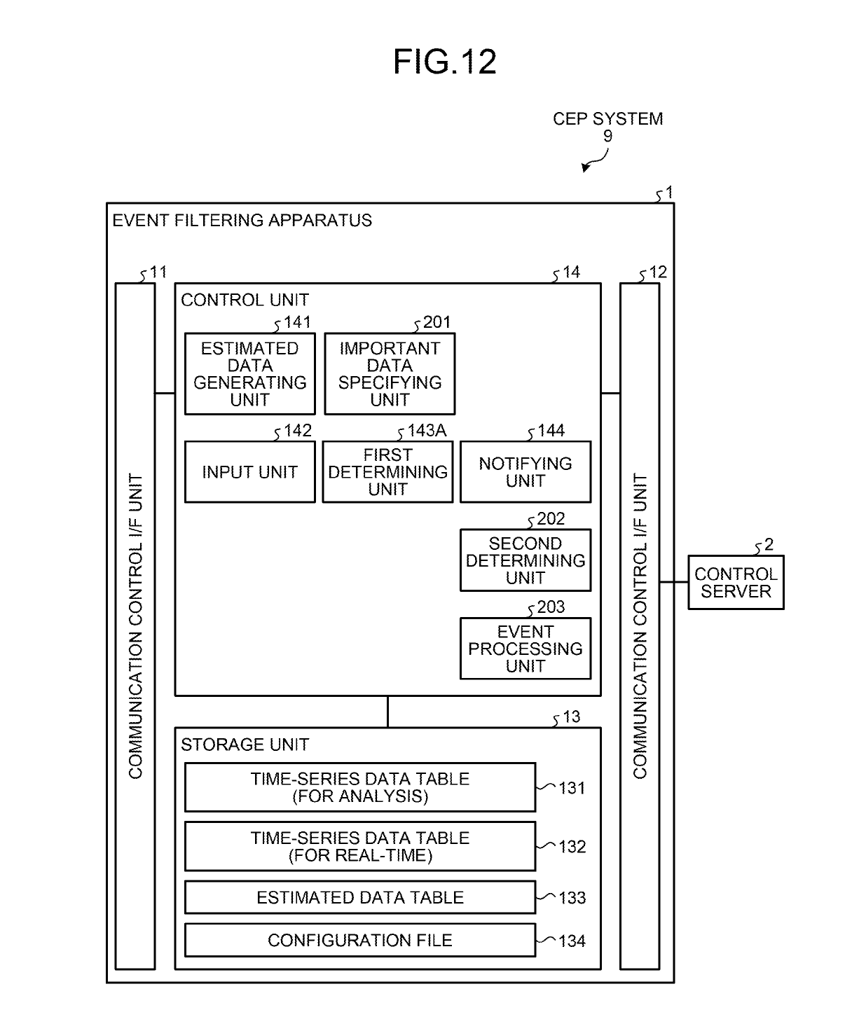

FIG. 12 is a diagram illustrating an overall configuration of a CEP system including an event filtering apparatus according to the third embodiment. The same components as those of the CEP system 9 illustrated in FIG. 8 are denoted by the same symbols, and explanation of the same configuration and operation will be omitted. The third embodiment is different from the second embodiment in that the control unit 14 further includes an event processing unit 203.

The event processing unit 203 is a processing unit that uses, for event processing, a determination result of determination on matching between an input event and an event that is deviated at the time of occurrence of an abnormality. The determination result is generated by the second determining unit 202. For example, the event processing unit 203 uses, for the event processing, a match result indicating that the input event matches the event deviated at the time of occurrence of an abnormality. Furthermore, the event processing unit 203 uses, for the event processing, a mismatch result indicating that the input event does not match the event deviated at the time of occurrence of an abnormality. Moreover, the event processing unit 203 counts the number of times of match between the input event and the event that is deviated at the time of occurrence of an abnormality, and adds 1 to the number of times of match when the determination result indicates match. Then, the event processing unit 203 notifies the control server 2 of a cumulative total value of the number of times of match. A timing of sending a notice may be regular or irregular as long as the timing is determined in advance.

Example of a Specific Process Performed by the CEP System

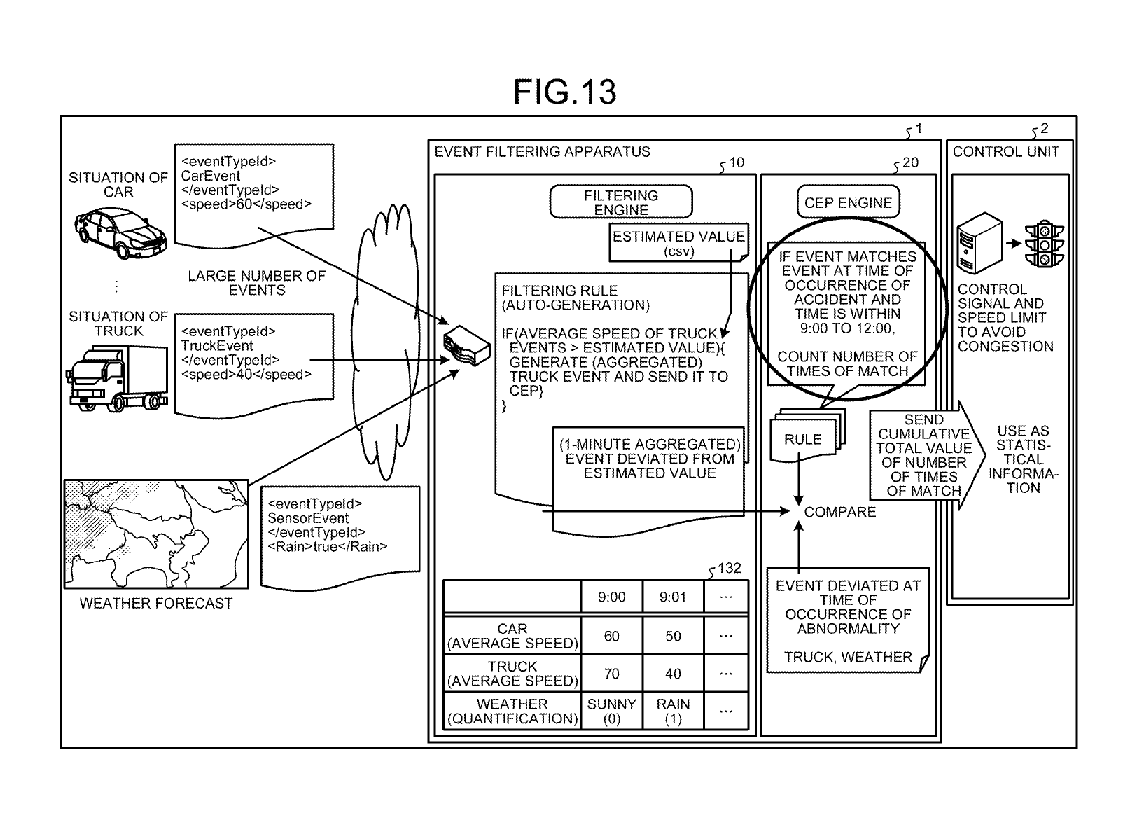

FIG. 13 is a diagram illustrating an example of a specific process performed by the CEP system according to the third embodiment. FIG. 13 illustrates a specific example of real-time processing at the time of operation. Incidentally, it is assumed that “one minute” is stored as the unit of generation and “one day” is stored as the unit of analysis in the configuration file 134. Furthermore, it is assumed that the first determining unit 143A generates the estimated data table 133 corresponding to the unit of analysis of “one day”. Moreover, it is assumed that the important data specifying unit 201 of the CEP engine 20 has received events that are deviated at the time of occurrence of an abnormality. Furthermore, it is assumed that the events deviated at the time of occurrence of an abnormality are a truck event and a weather event. Incidentally, the input unit 142 and the first determining unit 143A correspond to, for example, the filtering engine 10. Furthermore, the notifying unit 144, the second determining unit 202, and the event processing unit 203 correspond to, for example, the CEP engine 20.

As illustrated in FIG. 13, in the real-time processing at the time of operation, the filtering engine 10 of the event filtering apparatus 1 generates a filtering rule for each one minute that is the unit of generation, by using the estimated values stored in the estimated data table 133. Then, the filtering engine 10 determines whether the input event matches the generated filtering rule. If the input event matches the generated filtering rule, the filtering engine 10 sends an event, in which the input events for one minute are aggregated, to the CEP engine 20. That is, the filtering engine 10 sends an event deviated from the estimated value as an important event to the CEP engine 20. In other words, the filtering engine 10 sends an event deviated from the stationary state to the CEP engine 20.

Then, the CEP engine 20 generates a filtering rule for comparing the event that is deviated at the time of occurrence of an abnormality and the sent event. In this example, the CEP engine 20 generates, for example, a filtering rule for determining whether the sent event matches the truck event or the weather event. Then, when determining that the sent event matches the truck event or the weather event, the CEP engine 20 uses a match result for the event processing. When determining that the sent event does not match the truck event and the weather event, the CEP engine 20 uses a mismatch result for the event processing. Then, when determining that the sent event matches the truck event or the weather event, the CEP engine 20 adds 1 to the number of times of match. Incidentally, the CEP engine 20 may further add a condition to add 1 to the number of times of match. As one example, it may be possible to add a condition such that “an (occurrence) time is between 9:00 to 12:00” with respect to the sent event.

Then, the CEP engine 20 notifies the control server 2 of a cumulative total value of the number of times of match. The control server 2 can use the notified cumulative total value of the number of times of match as statistical information.

Flow of the Event Filtering Process

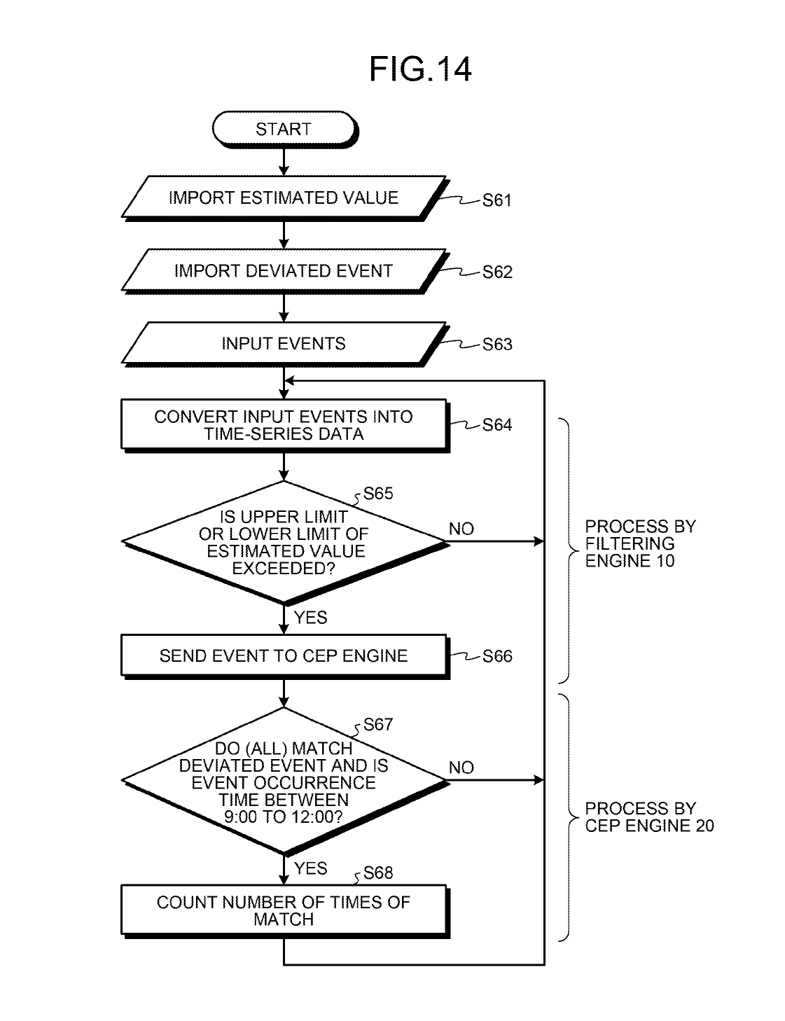

Next, the flow of the event filtering process will be described with reference to FIG. 14. FIG. 14 is a flowchart illustrating the event filtering process according to the third embodiment. Incidentally, a case will be described in which the unit of generation is set to one minute, and the unit of analysis is set to one day. Furthermore, in FIG. 14, it is assumed that the estimated data generating unit 141 exports the estimated value before operation starts. Moreover, it is assumed that the important data specifying unit 201 outputs an event that is deviated at the time of occurrence of an abnormality before operation starts.

In the event filtering process, the estimated value exported from the estimated data generating unit 141 is imported (Step S61). In the event filtering process, the deviated event output from the important data specifying unit 201 is imported (Step S62).

When operation starts, the input unit 142 continuously inputs events from input sources (Step S63). Accordingly, the first determining unit 143A converts the input events into time-series data (Step S64). As one example, the first determining unit 143A converts the input events into time-series values in the unit of generation (in the unit of one minute). Then, the first determining unit 143A stores the converted time-series values of the input events in the time-series data table (for real-time) 132.

Then, the first determining unit 143A determines whether the value of the current input event exceeds the upper limit or the lower limit of the estimated value (Step S65). For example, the first determining unit 143A generates a filtering rule by using the current estimated value corresponding to the unit of one minute, and determines whether the current input event matches the filtering rule. As one example, the first determining unit 143A generates a filtering rule such that “if an average speed of truck events exceeds an upper limit or a lower limit of an estimated value, an aggregated truck event for one minute is generated and sent to the CEP engine 20”. Then, the first determining unit 143A determines whether the value of the current input event matches the condition of the filtering rule.

When determining that the upper limit or the lower limit of the estimated value is not exceeded (NO at Step S65), the first determining unit 143A causes the process to proceed to Step S64 to process a next input event.

In contrast, when determining that the upper limit or the lower limit of the estimated value is exceeded (YES at Step S65), the first determining unit 143A generates an aggregated event corresponding to one minute from the input events, and sends the generated event to the CEP engine 20 (Step S66). Then, the first determining unit 143A causes the process to proceed to Step S67.

At Step S67, the event processing unit 203 of the CEP engine 20 determines whether the sent event matches an event that is deviated at the time of occurrence of an abnormality, and the occurrence time of the sent event is between 9:00 and 12:00 (Step S67). When determining that the sent event matches the event deviated at the time of occurrence of an abnormality, and the occurrence time of the sent event is between 9:00 and 12:00 (YES at Step S67), the event processing unit 203 counts the number of times of match (Step S68). Then, the event processing unit 203 causes the process to proceed to Step S64 to process a next input event.

In contrast, when determining that the sent event does not match the event deviated at the time of occurrence of an abnormality, or the occurrence time of the sent event does not fall within a time from 9:00 to 12:00 (NO at Step S67), the event processing unit 203 does not count the number of times of match. Then, the event processing unit 203 causes the process to proceed to Step S64 to process a next input event.

Incidentally, the notifying unit 144 notifies the control server 2 of a cumulative total value of the number of times of match at a predetermined timing. Furthermore, if an interrupt indicating termination is received, the event filtering process is terminated.

Effects of the Third Embodiment

According to the above-described third embodiment, the event filtering apparatus 1 determines whether an event sent from the filtering engine 10 is abnormal on the basis of a pre-stored event that is deviated at the time of occurrence of an abnormality, and uses a determination result for the event processing. With this configuration, the event filtering apparatus 1 can realize complex event processing by using the event, which is deviated at the time of occurrence of an abnormality, for determination to select the most important event, and by using a determination result for the event processing.

### [d] Fourth Embodiment

In the first to the third embodiments, an example has been described in which the CEP system 9 is used to predict occurrence of congestion of cars. However, the CEP system 9 is not limited to the example, but may be used for different purposes. For example, the CEP system 9 may be used as a management system of a production line in a factory.

Therefore, in a fourth embodiment, a case will be described in which the CEP system 9 is used to manage a production line in a factory.

Example of a Specific Process Performed by the CEP System

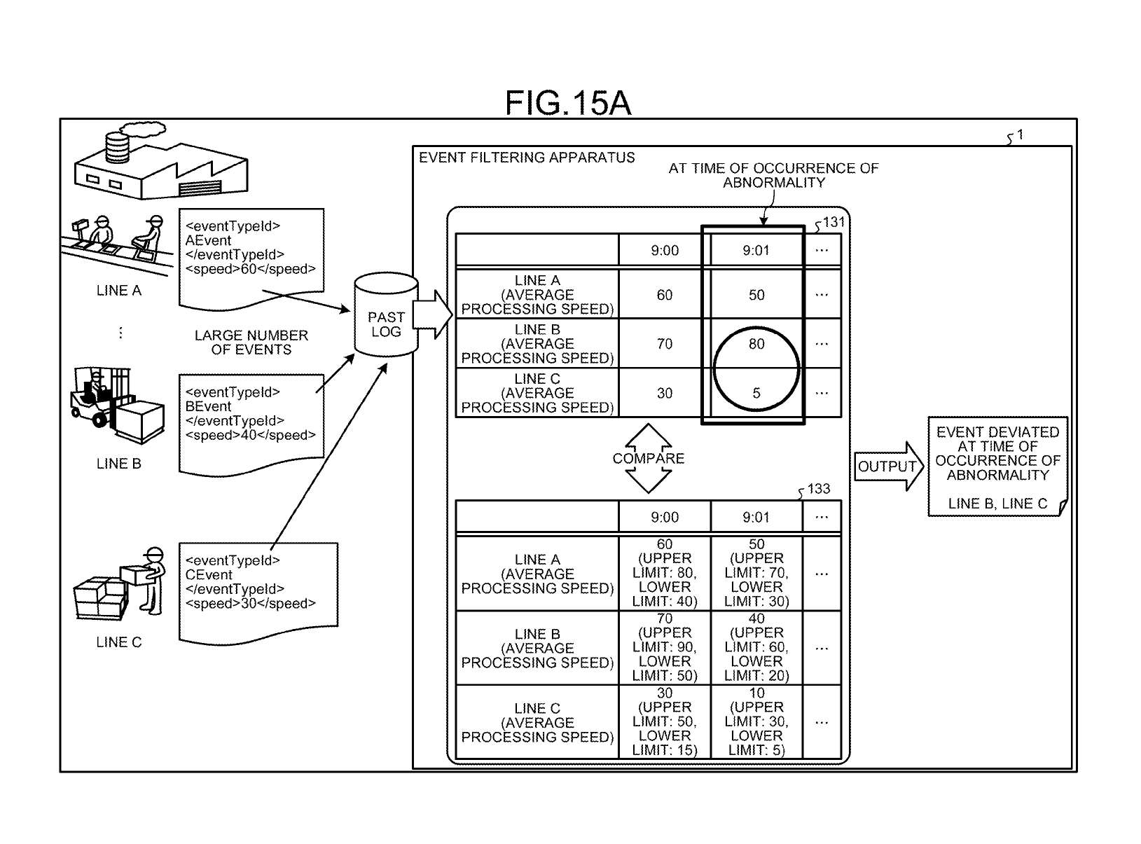

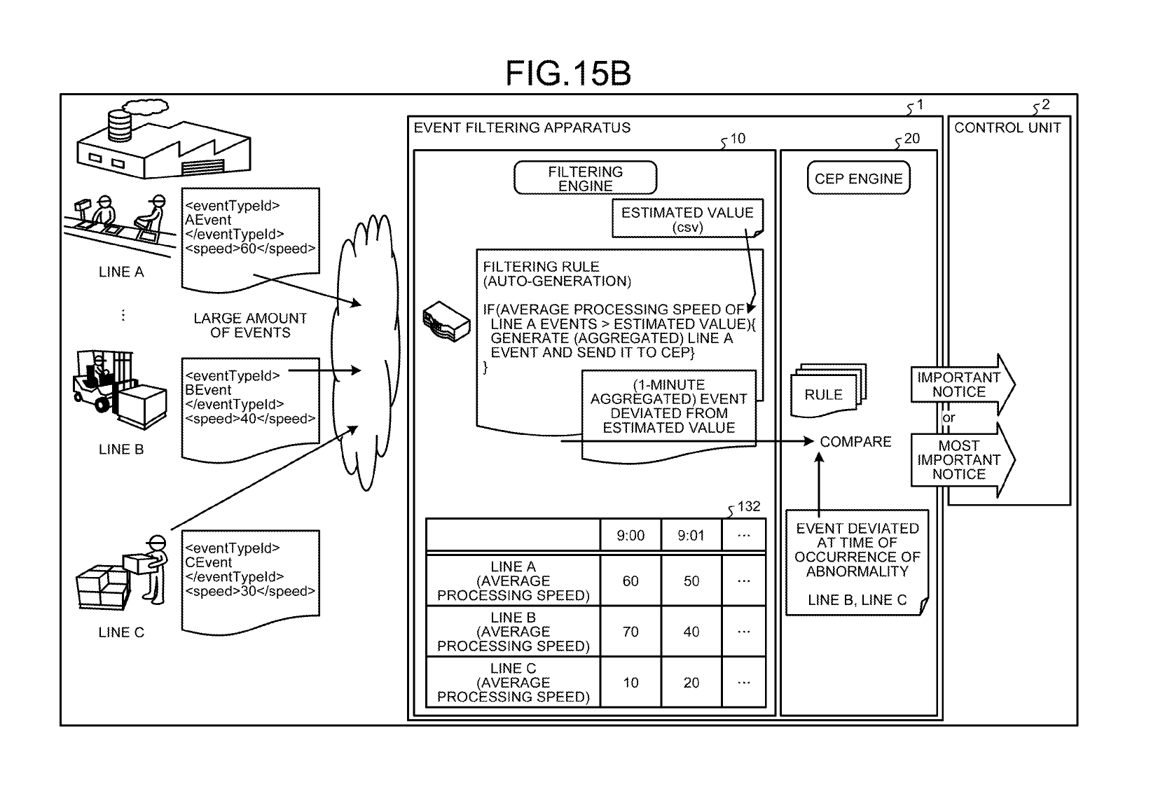

FIG. 15A and FIG. 15B are diagrams illustrating an example of a specific process performed by the CEP system according to the fourth embodiment. In FIG. 15A and FIG. 15B, an example is illustrated in which the event filtering apparatus 1 receives input of a large amount of events from a line A, a line B, and a line C in a factory. FIG. 15A illustrates a specific example of a process performed at the time of an analysis. FIG. 15B illustrates a specific example of real-time processing at the time of operation. Incidentally, it is assumed that “one minute” is stored as the unit of generation and “one day” is stored as the unit of analysis in the configuration file 134. Furthermore, it is assumed that the first determining unit 143A generates the estimated data table 133 corresponding to the unit of analysis of “one day”.

As illustrated in FIG. 15A, the event filtering apparatus 1 extracts events of the line A, the line B, and the line C at the abnormality occurrence date from a past log, and stores the events in the time-series data table (for analysis) 131. The event filtering apparatus 1 acquires values of the respective events at the abnormality occurrence date and time among time-series values of the respective events. Here, as one example, it is assumed that the abnormality occurrence date and time is “9:01”. Accordingly, “50” is acquired as a value indicating a tendency of the line A (average processing speed) at the time of “9:01”, “80” is acquired as a value indicating a tendency of the line B (average processing speed), and “5” is acquired as a value indicating a tendency of the line C (average processing speed).

Then, the event filtering apparatus 1 compares the acquired values of the respective events and the estimated values of the respective events at the time corresponding to the abnormality occurrence date and time, and extracts events deviated from the estimated values. In this example, the estimated value indicating the tendency of the line A (average processing speed) at the time corresponding to the abnormality occurrence date and time of “9:01” is “50”, the estimated value indicating the tendency of the line B (average processing speed) is “40”, and the estimated value indicating the tendency of the line C is “10”. In this case, the value of the line A (average processing speed) at the abnormality occurrence date and time is the same as the estimated value of the line A (average processing speed) at the corresponding time, and therefore is not deviated from the estimated value. In contrast, the value of the line B (average processing speed) at the abnormality occurrence date and time is greater than the estimated value of the line B (average processing speed) at the corresponding time, and therefore is deviated from the estimated value. Furthermore, the value of the line C (average processing speed) at the abnormality occurrence date and time is smaller than the estimated value of the line C (average processing speed) at the corresponding time, and is therefore deviated from the estimated value. Therefore, the event filtering apparatus 1 extracts the event of the line B and the event of the line C that are deviated from the estimated values with respect to the abnormality occurrence date and time of “9:01”.

Then, the event filtering apparatus 1 outputs the events that are deviated at the abnormality occurrence date and time to the CEP engine 20. In this example, the event filtering apparatus 1 outputs the event of the line B and the event of the line C at the abnormality occurrence date and time of “9:01” to the CEP engine 20. At this time, the event filtering apparatus 1 may output the events with the respective values. The output events are used in the real-time processing at the time of operation.

As illustrated in FIG. 15B, in the real-time processing at the time of operation, the event filtering apparatus 1 performs the following process. The filtering engine 10 of the event filtering apparatus 1 calculates an average processing speed indicating a tendency of a feature amount related to the event of the line A, from a plurality of events of the line A that are input from input sources during one minute. Similarly, the filtering engine 10 calculates an average processing speed indicating a tendency of a feature amount related to the event of the line B, from a plurality of events of the line B that are input from input sources during one minute. The filtering engine 10 calculates an average processing speed indicating a tendency of a feature amount related to the event of the line C, from a plurality of events of the line C that are input from input sources during one minute. Then, the filtering engine 10 stores the calculated events of the line A, the line B, and the line C in the time-series data table (for real-time) 132.

In parallel with the above process, the filtering engine 10 generates a filtering rule by using the estimated values stored in the estimated data table 133. In this example, the filtering engine 10 generates a filtering rule for the event of the line A such that, for example, “if an average processing speed of events of the line A exceeds an estimated value, an aggregated event of the line A corresponding to one minute is generated and sent to the CEP engine 20”. As one example, in the case of the period “9:00” indicating the period from “9:00” to before “9:01”, the filtering engine 10 performs the following process. That is, the filtering engine 10 assigns “60”, which indicates the line A (average processing speed) in this period, into a part corresponding to the average speed of the event of the line A in the filtering rule, and assigns the estimated value of the line A (average processing speed) in this period into a part corresponding to the estimated value. If the filtering rule is satisfied as a result of the assignment, the filtering engine 10 sends, to the CEP engine 20, an event in which the events of the line A during this period are aggregated for one minute. That is, the filtering engine 10 sends an event that is deviated from the estimated value as an important event to the CEP engine 20. In other words, the filtering engine 10 sends an event that is deviated from the stationary state to the CEP engine 20. If the filtering rule is not satisfied as a result of the assignment, the filtering engine 10 does not send the events of the line A of this period to the CEP engine 20.

Then, the CEP engine 20 generates a filtering rule for comparing the output event and the sent event. In this example, the CEP engine 20 generates a filtering rule for, for example, determining whether the sent event matches the output event of the line B or the output event of the line C. Then, when determining that the sent event matches the output event of the line B or the output event of the line C, the CEP engine 20 sends, as the most important notice, a notice of occurrence of an abnormality to the control server 2. That is, when the sent event is the same as the event that is deviated at the time of occurrence of an abnormality, an abnormality is likely to occur; therefore, the CEP engine 20 reports the event as a most important event. As one example, the CEP engine 20 sends a notice of “a probability of occurrence of an accident is increased” to the control server 2. When determining that the sent event does not match the output event of the line B and the output event of the line C, the CEP engine 20 sends a notice of occurrence of an abnormality as the important notice to the control server 2. As one example, the CEP engine 20 sends a notice of “there is the possibility of abnormality” to the control server 2.

As described above, even when the CEP system 9 is used to manage production lines in a factory, the event filtering apparatus 1 can achieve the following effects. That is, the event filtering apparatus 1 uses, for determination, an event at the time of occurrence of an abnormality, and therefore can send the most important notice to the control server 2 when the same event is input, and can support control of the control server 2.

Program or the Like

In the above-described embodiments, examples have been described in which the CEP system 9 is used to predict occurrence of congestion of cars and the CEP system 9 is used to manage production lines in a factory. However, the CEP system 9 is not limited to these examples, but may be used for different purposes.

Furthermore, in the above-described embodiments, an example has been described in which the event filtering apparatus 1 sets the unit of generation to one minute and sets the unit of analysis to one day; however, it is not limited thereto, and the event filtering apparatus 1 may set the unit of generation to ten minutes and set the unit of analysis to one week. Alternatively, the unit of generation may be set to one hour and the unit of analysis may be set to one month. That is, it is sufficient that the unit of generation and the unit of analysis are defined in the configuration file 134 and the units may be changed as needed.

Moreover, the event filtering apparatus 1 may be implemented by mounting various functions of the above-described control unit 14, the storage unit 13, and the like on an information processing apparatus, such as a known personal computer or a workstation.

The components of the apparatuses illustrated in the drawings need not necessarily be physically configured in the manner illustrated in the drawings. That is, specific forms of distribution and integration of the apparatuses are not limited to those illustrated in the drawings, and all or part of the apparatuses may be functionally or physically distributed or integrated in arbitrary units depending on various loads or use conditions. For example, the second determining unit 202 and the notifying unit 144 may be integrated into a single processing unit. In contrast, each of the determining unit 143 and the first determining unit 143A may be distributed into a generating unit that generates filtering by using an estimated value and a determining unit that determines a current value by using the filtering. Furthermore, the time-series data tables 131 and 132, the estimated data table 133, the configuration file 134, and the like may be connected as an external apparatus of the event filtering apparatus 1 via a network.

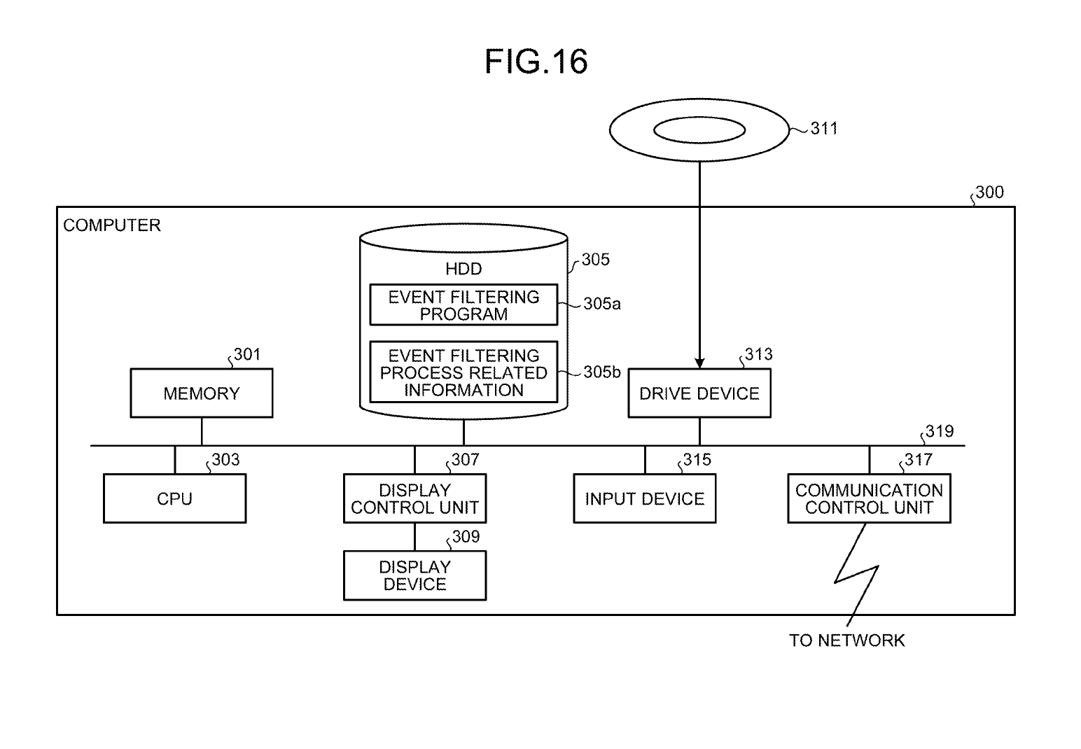

Moreover, the various processes described in the above-described embodiments may be implemented by causing a computer, such as a personal computer or a workstation, to execute a program prepared in advance. Therefore, in the following, an example of a computer that executes an event filtering program for implementing the same functions as those of the event filtering apparatus 1 illustrated in FIGS. 1, 8, and 12 will be described. FIG. 16 is a diagram illustrating an example of the computer that executes the event filtering program.

As illustrated in FIG. 16, a computer 300 includes a CPU 303 that executes various kinds of arithmetic processing, an input device 315 that receives input of data from a user, and a display control unit 307 that controls a display device 309. The computer 300 further includes a drive device 313 that reads a program or the like from a storage medium, and a communication control unit 317 that transmits and receives data to and from other computers via a network. The computer 300 further includes a memory 301 and an HDD 305 for temporarily storing various kinds of information. The memory 301, the CPU 303, the HDD 305, the display control unit 307, the drive device 313, the input device 315, and the communication control unit 317 are connected to a bus 319.

The drive device 313 is a device used for a removable disk 311, for example. The HDD 305 stores therein an event filtering program 305a and event filtering process related information 305b.

The CPU 303 reads the event filtering program 305a, loads the program on the memory 301, and executes the program as a process. The process corresponds to each functional unit of the event filtering apparatus 1. The event filtering process related information 305b corresponds to the time-series data tables 131 and 132, the estimated data table 133, and the configuration file 134. For example, the removable disk 311 stores therein information, such as the event filtering program 305a.

Incidentally, the event filtering program 305a need not necessarily be stored in the HDD 305 from the beginning. For example, the program may be stored in a “portable physical medium”, such as a flexible disk (FD), a compact disk-read only memory (CD-ROM), a digital versatile disk (DVD), a magnetooptical disk, or an IC card, which is inserted in the computer 300. Then, the computer 300 reads the event filtering program 305a from the portable physical medium and executes the program.

According to an embodiment of the event filtering program of the disclosed technology, it is possible to appropriately filter an event in complex event processing.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention have been described in detail, it should be understood that the various changes, substitutions, and alterations could be made hereto without departing from the spirit and scope of the invention.

What is claimed is:

1. A non-transitory computer-readable recording medium having stored therein a program for causing a computer to execute a process comprising:
estimating a value indicating a tendency of a feature amount related to a current event on the basis of a change in a tendency of a feature amount related to a past input event;
calculating a value indicating a tendency of a feature amount related to a current event on the basis of an input current event; and
setting filtering of an event to be a target event for event processing, on the basis of the estimated value and the calculated value.

2. The non-transitory computer-readable recording medium according to claim 1, wherein the estimating includes chronologically estimating a value indicating a tendency of a feature amount related to a current event, on the basis of a change in a tendency of a feature amount of a past input event.

3. The non-transitory computer-readable recording medium according to claim 1, wherein the setting includes setting a rule for filtering an event corresponding to the calculated value when the calculated value matches the estimated value.

4. The non-transitory computer-readable recording medium according to claim 1, the process further including:
determining whether an event sent to the processing unit is abnormal on the basis of a pre-stored event that is deviated at the time of occurrence of an abnormality; and
notifying a determination result indicating an abnormality when the event is determined as abnormal.

5. The non-transitory computer-readable recording medium according to claim 4, wherein the notifying uses the determination result for the event processing.

6. An event filtering apparatus comprising:
a processor, wherein the processor executes:
estimating a value indicating a tendency of a feature amount related to a current event on the basis of a change in a tendency of a feature amount related to a past input event;
calculating a value indicating a tendency of a feature amount related to a current event on the basis of an input current event; and
setting filtering of an event to be a target event for event processing, on the basis of the estimated value and the calculated value.

7. An event filtering method implemented by a computer, the method comprising:
estimating a value indicating a tendency of a feature amount related to a current event on the basis of a change in a tendency of a feature amount related to a past input event using a processor;
calculating a value indicating a tendency of a feature amount related to a current event on the basis of an input current event using the processor; and
setting filtering of an event to be a target event for event processing, on the basis of the estimated value and the calculated value using the processor.
